(19) United States
(12) Patent Application Publication
(10) Pub. No.: US 2012/0145779 A1
(43) Pub. Date: Jun. 14, 2012

(54) TWO-DIMENSIONAL SYMBOL CODE AND METHOD FOR READING THE SYMBOL CODE

(75) Inventors: Felix Bietenbeck, Bad Homburg (DE); Herbert Zimmermann, Friedrichsdorf (DE); Torben Weis, Duisburg (DE); Josef Pauli, Duisburg (DE); Johannes Herwig, Duisburg (DE)

(73) Assignee: Continental Teves AG & Co. oHG, Frankfurt (DE)

(21) Appl. No.: 13/262,850

(22) PCT Filed: Apr. 8, 2009
(86) PCT No.: PCT/EP2009/054271

§ 371 Date: Feb. 23, 2012

(51) Int. Cl. G06K 19/06; G06F 17/00; G06K 7/10

(52) U.S. Cl. 235/375; 235/494; 235/462.1; 235/462.04

(57) ABSTRACT

The specification describes a two-dimensional symbol code for representing binary data, which symbol code is constructed from a plurality of graphical symbols arranged next to one another, wherein the symbol code is formed from precisely two different symbols having the same surface area which differ in their areal brightness distribution and each code a value from a binary data word. The symbols have a complementary brightness distribution. In a method for reading this two-dimensional system code, the system code has a filter applied to it which matches the brightness distribution of one of the two complementary symbols, wherein in the event of a match one symbol is recognized and in the event of no match the other symbol is recognized.

### CROSS REFERENCE TO RELATED APPLICATION

This application is the U.S. National Phase Application of PCT/EP2009/054271, filed Apr. 8, 2009, the contents of such applications being incorporated by reference herein.

### FIELD OF THE INVENTION

The invention relates to a two-dimensional, in particular machine-readable, symbol code for representing binary data, which symbol code is constructed from a plurality of graphical symbols arranged next to one another in a preferably horizontal and/or vertical direction, wherein the symbol code is formed from precisely two different symbols having the same surface area which differ in their areal brightness distribution and each code a value from a binary data word. In addition, the invention describes a method for reading said symbol code, a particularly preferred use and a suitable reading apparatus.

### BACKGROUND OF THE INVENTION

In order to automate the production and quality checking of products, single components which are assembled on a production line, primarily automatically, to form an overall product are marked with machine-readable symbol codes comprising graphical symbols. At assembly or checking stations in a production plant, readers are positioned such that they can capture, read and evaluate the applied symbol codes. On the basis of this evaluation, the further production flow can then be controlled, by way of example by virtue of a production separating filter responding, the object being gripped by a robot arm or other measures.

If a particular component is intended to be marked with a machine-readable symbol code, subsequently also called code to simplify matters, two-dimensional matrix codes have been set up. In comparison with one-dimensional bar codes, two-dimensional codes have a much higher data density, i.e. it is possible to encode more data information for the same space requirement on external surface area of the object to be marked.

Simple two-dimensional codes can be understood to be a stack of one-dimensional codes. By contrast, two-dimensional matrix codes store data words over a surface area. Widely used one-dimensional codes are: EAN (European Article Number, ISO/IEC 15420), IAN (International article numbering), JAN (Japanese article numbering), 2/5 Interleaved (ISO/IEC 16390), Code 39 (ISO/IEC 16388), Code 93 and Code 128. Stacked one-dimensional codes which are known are as follows: Codablock or PDF417.

Widely used two-dimensional matrix codes are: QR code (quick response code, ISO/IEC 18004), DataMatrix (DIN V 66401), MaxiCode, Aztec Code, Dotcode, MicroGlyph, Panamarks, Semacode, UPCODE, Trillcode, Quickmark, Shotcode, connexto or Beetagg.

One-dimensional bar codes are used for automation only where few data items need to be stored, the available surface area for applying the marker is large and no soiling can be expected. Usually, such a surface area for application is several centimeters in size and many times wider than high. Since numerical or alphanumerical characters are coded by varying the intervals between light and dark bars and the bar width, successful evaluation in practice requires a contrast of between 50 and 60%. For the same reason, soiling results in unrecoverable read errors. These bar codes have no opportunity for error correction, but have inbuilt parity bits for error recognition. Although a read error can therefore be noticed, it cannot be corrected, which is why they are not sufficiently robust for the purpose cited at the outset.

Stacked two-dimensional codes have an increased data density. A typical print of the PDF417 code is between 7 and 15 cm² in size and attains a typical data density of between 15.5 and 46.5 bytes per cm². The maximum code size is limited to 2000 8-bit (byte) characters. The PDF417 code is error-corrective. In the case of stacked codes, however, the scan line for the read operation needs to be exactly above the equivalent graphical symbol line, which limits the compactness which can be achieved thereby. The coding can be carried out in a manner optimized for numerical, alphanumerical and binary data.

Two-dimensional matrix codes are error-corrective and compact, since the data values called words are stored areally. The binary data are thus stored directly and no distinction is drawn between numerical or alphanumerical values. Usually, there exist a graphical symbol, which characterizes a one-word, and a second graphical symbol, which characterizes a zero-word, respectively. In some matrix codes, for example Data Matrix, the characterization of the zero-word also exists as a result of the absence of the symbol for a one-word at this position. This increases susceptibility to error, however, since the nonrecognition of a symbol can lead to the assumption that the other symbol is coded at that point, even if there is merely soiling or overlay, for example. In the case of a matrix code, a marking region is divided row by row and column by column into cells, which are usually of the same size, in the manner of a grid. A symbol is written into each of these cells.

A two-dimensional symbol code is then either printed onto a tag made of paper and said tag is stuck onto the object that is to be marked, or what is known as the DPM (direct part marking) method is used to burn or, generally, apply it to the object directly using a laser, in particular. If laser technology is used to directly burn the graphical symbols of such a machine-readable code onto a mechanical or electronic component, it is necessary to take account of limitations related to process engineering which affect the optical quality of the applied markings and adversely affect later decoding of the individual symbols by an image processing system.

The data matrix code is a square or rectangular symbol matrix which comprises white (unmachined regions) and black (machined regions) square cells which each code the value of a single bit. It has a solid black line, called a “finder pattern”, which prescribes the symbol region in the X and Y directions and which can be used by the image processing to locate and remove distortions from the symbol matrix. The respective opposite sides contain a fixed pattern for synchronization which contains white and black squares in alternate order in a line, said squares indicating the height and width of a row or column of the symbol matrix. Some of the symbol matrixes can be placed directly next to and above one another. Data Matrix supports ECC200 error correction based on Reed-Solomon with up to 60% redundant information. There must be a contrast difference of at least 20% between white and black graphical symbols.

The QR code (quick response code) is square in shape and was developed for the purpose of marking assemblies and components in automobile production. The QR code has four special symbols for easily recognizing the position and the orientation thereof, said symbols being called anchors. These are used for localization and distortion removal. Three of these anchors are used as principal anchors for position recognition, and a further, smaller anchor is used for orientation. Words, i.e. the associated data values, are coded in graphical symbols which represent black filled (machined regions) and white omitted (unmachined regions) squares, similar to Data Matrix. For the purpose of synchronization, the symbol matrix contains a linear pattern of alternately filled and unfilled squares for each direction axis. The QR code is available in various types and formats, with the type and format being firmly coded in addition to the three principal anchors. Subsequently, the actual data symbols can be extracted and decoded. The QR code supports up to 30% redundant information by virtue of Reed-Solomon error correction.

While Data Matrix and QR code have woven special graphical patterns for recovering the clocking into the graphical symbol matrix, the MicroGlyph code developed by Xerox Corporation is self-clocking and does not require such synchronization patterns. This code is described in U.S. Pat. No. 5,862,271, for example.

The property of self-clocking is achieved, in principle, by virtue of adjacent graphical symbols not fusing with one another, as is the case with Data Matrix and QR, for example, when at least two respective black or white square symbols are direct neighbors. The graphical symbols are in this case called Glyphs and are printed onto a surface area in a predetermined distribution of tiled data cells. A data cell contains the graphical symbol which codes a word. One of these data cells can be regarded as a pixel image into which a graphical symbol is drawn, with as little drawing as possible taking place in the outer marginal region of a data cell in order to keep adjacent data cells separable from one another.

The shape of such a graphical symbol is allocated a word. In this case, such a shape has one or more characteristic features. All of the manifestations—which are available for a specific instance of such a graphical symbol—of the characteristic shape features specify the coded word. In order to decode a word from a given graphical symbol, the image analysis involves the application of a plurality of filters to the graphical symbol which each have a particularly good response to a single instance from the possible prescribed shape features and at the same time produce as little filter response as possible for all other, possibly additionally available, shape features. When each filter has been applied, the filter responses of all filters are taken as a basis for decoding the word in a serial procedure.

If specifically one binary word is coded in graphical symbols, two characteristic shape features and therefore a total of two filters are necessary. For the purpose of perspective distortion removal, a rectangular or square symbol matrix is assumed, so that the relevant parameters can be calculated from graphical symbols situated at corners or from three reference points with a similar configuration. Attachment just to the most planar possible surface areas is therefore a possibility. In this case too, the decoding is supported by Reed-Solomon error correction for the coded binary words.

In the case of MicroGlyph, a plurality of filters are applied and the responses thereof are stored in two dimensions topologically in a response image. In this case, filter responses should accumulate at positions which can be associated with a glyph. Similar concepts are also used in other methods, with the problem arising that it is necessary to find local maxima for the filter responses. It is also possible for the manifestation and number of the filter responses to vary greatly as a result of (partial) damage to the symbol code original which needs to be filtered. In addition, the topological position of said filter responses also cannot be exactly predicted in the local region of expected neighbors. Therefore, the ordinarily tracked approaches and analysis methods regularly give rise to problems in the decoding, particularly if the external circumstances are not optimum, for example as a result of reflections or curved surfaces.

Within the context of the known methods, absolute threshold value formation can be used to define for an obtained response image a pixel set which has a high probability of containing exclusively symbol centers or pixels very close to these centers. This dot set can be split into subsets, which each correspond to the catchment area of a symbol, by minimizing the Euclidian intervals for the distances of all dots in a cluster from the latter's own focal point. This can be achieved using the K-means algorithm, for example. The pixel with the maximum response value within each subset then describes the most probable symbol center. In accordance with one alternative, threshold value formation can produce a threshold value image which contains only pixels of a filter response having values above a set threshold value.

The pixel with the maximum filter response can safely be assumed to be a symbol center. On the basis of this starting point, when the stepsize (the side length of a symbol template) is known, it is possible to attempt to explore the further symbol centers on the basis of a prescribed grid pattern or adaptively in line with the expected arrangement of the symbol cells. In this case, successive symbol centers are estimated by incrementing coordinates, and then the position thereof is corrected by looking for a maximum grayscale value in the threshold value image in a small local environment around this estimate (from approximately 20 to 25 percent of the side lengths of the symbol template). The associated pixel is then set as a symbol center, since it can be assumed that it is an improved estimate of the position.

Both previously indicated methods for extracting symbol centers have the drawback that only pixels with values above a global threshold value are considered as possible symbol centers. If the symbol matrix in a particular region is highly soiled, scratched or otherwise destroyed, the previously stipulated threshold values may not be reached and the information contained in this symbol code region may be rejected. The reason is that if the global threshold value is chosen to be too high, sometime no symbol centers at all are presumed to be in the damaged region. If the global threshold value is lowered in response thereto, evidence of possible symbol centers may also arise in the damaged region. At the same time, however, a multiplicity of pixels are additionally classified as probable symbol centers in undamaged regions, which makes the location of true symbol centers more difficult and results in erroneous estimates.

When a graphical symbol code is attached to a component with a highly reflective surface, the reliability for recognizing and decoding the symbol code into data words is significantly decreased. The customary Data Matrix and QR codes and MicroGlyph involve the error correction function inbuilt in the binary words to be coded attempting to make it possible to ignore the noncapture of individual or relatively large regions of graphical symbols which are overexposed and hence worthless as a result of reflection from the surface in the snapshot. However, the extraction of correctly exposed image portions also becomes difficult, since the variances in the grey scale values are great on account of local brightness differences caused by the reflective material. Thus, it is necessary to apply adaptive methods in the image evaluation for preprocessing, the success of which is likewise limited, and possibly even destroys usable brightness information, on account of abrupt changes in the local brightness. An attempt is made to achieve the most homogenous possible, diffuse illumination of the relevant region in order to support the image processing. Specific illumination is not always possible, however, on account of a lack of space.

If a DPM (direct part marking) method is not absolutely necessary, it is possible for the symbol code to be printed onto a paper tag which is then stuck onto the object to be marked. Although this allows successful reading of the marking, the additional paper on the object is a foreign body which can result in quality problems in the production process. If the marked object is gripped by a robot arm for the purpose of transportation, for example, small paper fibers can become worn from the paper tag and can drop from the robot arm and destroy electronic components. In heat-intensive production cycles, a paper tag is not an option on account of the risk of fire. If the symbol code is intended to remain inseparably connected to an object for the purpose of explicit identification, a stuck paper tag also provides no protection against manipulation by means of simple replacement. Furthermore, an additional processing step for sticking on the tag is introduced into the planned production cycle.

If it is not possible to dispense with a DPM (direct part marking) method, the reflective surface to be marked can be roughened before the symbol code is burned on by the laser, so that the object background is matt and nonreflective. This can avoid the problem of severe reflection. However, the contrast is reduced and the roughening takes additional time, which limits a reduction in the clock cycles.

### SUMMARY OF THE INVENTION

It is therefore an object of the present invention to propose a two-dimensional system code which is robust, effective and can be decoded with a high level of certainty, and a reading method which is optimized therefor, said system code and reading method being able to be used to improve the reliability of identification, particularly also in real production environments. One aspect of the invention achieves this object for a two-dimensional system code of the type cited at the outset by means of a two-dimensional symbol code for representing binary data, which symbol code is constructed from a plurality of graphical symbols arranged next to one another, wherein the symbol code is formed from precisely two different symbols having the same surface area which differ in their areal brightness distribution and each code a value from a binary data word, wherein in that the symbols have a complementary brightness distribution. In this context, it is proposed that the symbols have a complementary brightness distribution.

In this regard, each of the two symbols may preferably comprise an areal arrangement of at least two regions which each have precisely one of two prescribed brightness values. Every single symbol therefore has two different brightnesses, i.e. a brightness distribution. One of the two brightness values can be logically assigned the value “bright” and the other of the two brightness values can be logically assigned the value “dark”. A particular combination of the locally distributed brightness values “bright” and “dark” within a symbol then has an associated data word. For this, any brightness difference between the two regions that can be measured by a detector arrangement is sufficient, in principle, in accordance with aspects of the invention. These regions are subsequently called “bright” and “dark” to simplify matters.

A complementary brightness distribution is achieved, in particular, by virtue of each of the two symbols required for explicitly coding a binary word having the same areal extent or arrangement of the regions, with which, for each determined symbol, precisely the different (opposite) instances of the total of two brightness values “bright” and “dark” are associated, however, each section of the surface area associated with a symbol being associated with one of these two brightness values.

Since each of these complementary symbols has one of the two possible values of the binary data word explicitly associated with it and the complementary design of the symbols has achieved maximum distinguishability, this symbol code is particularly robust. It is therefore also suited to curved and reflective surfaces, in particular, to which the symbol code can also be applied directly by means of surface machining, particularly if the inner brightness regions of the symbols have their distribution chosen to be as invariant as possible in relation to the expected occurring distortion. Such a DPM (direct part marking) method is frequently carried out using a laser, which is used to burn the symbol code on a surface. Within the context of the marking accuracy, overlaps between the bright and dark regions can occur in this case which, in accordance with aspects of the invention, are not an obstacle to the complementary arrangement of the regions.

In summary, each symbol in the symbol family thus comprises a multiplicity (at least two) of physically cohesive regions, with all symbols in a family having the same arrangement of regions. Each of these regions has either a logically bright or dark filling, not all of these regions for a symbol being logically bright or logically dark at the same time. It is thus possible for two mutually complementary symbols to be presented, and every single one of the symbols can be explicitly associated with a value of a binary word.

A characteristic of the complementary design of the symbols is that the decision regarding which of the two symbols is depicted requires only the use of a single filter which corresponds to one of the two symbols. If the filter matches the symbol, a match which is ideally even complete is obtained. In the case of a filter which is complementary with respect to the symbol, an ideally complete discrepancy is obtained. Within the context of image evaluation, distinction between the complementary symbols is assured, however, even if the marking accuracy means that overlaps between bright and dark regions of the symbols are obtained because in that case the use of one filter results in a predominant match with or a predominant discrepancy from the symbol of the symbol code.

In accordance with one preferred form of an aspect of the invention, each symbol comprises precisely two, in particular cohesive, regions, wherein the two regions each have an associated different brightness value. The surface areas of the two regions in a symbol may, in accordance with aspects of the invention, be essentially of the same size, with discrepancies in the surface area content between the two regions in the order of magnitude of up to approximately 1/9 of the total surface area being regarded as essentially of the same size. The background to this discrepancy is that, in accordance with one preferred embodiment of an aspect of the invention, provision is made for a graphical symbol from the symbol code to have a square base area which, for the purpose of defining the regions of the symbol, is split into 3×3 pixels. Even if the present invention is not limited to such a matrix arrangement, such an arrangement can, in practice, be evaluated particularly easily both when generating and when reading the symbol code. In this case, a 3×3 matrix offers optimum equalization between the symbol size that is required for a single symbol within the context of optical resolution (distinguishability) and a sufficiently high data density. In such a matrix, a region with the first brightness value can be allocated 4/9 of the total surface area of the symbol and a second region with the second brightness value can be allocated 5/9 of the total surface area of the symbol. The difference in size between the two regions is thus in the order of magnitude of 1/9 of the total surface area content of the symbol.

In accordance with one preferred embodiment of an aspect of the invention, the two regions are each constructed from physically cohesive surface areas. This allows vector-oriented generation of the areal symbol code, for example by moving a switched-on laser along a defined movement path, without needing to switch the laser on or off during movement in order to produce the marking corresponding to the areal symbol. Areally cohesive regions also minimize the transition between the two brightness regions, which is always erroneous in practice. This improves the achievable distinguishability of the symbols and reduces the error rate when reading the areal symbol code.

A square symbol which is particularly preferred in accordance with aspects of the invention has, along a section through the center of the symbol, which section runs parallel to the lateral edges of said symbol, a distribution for the logical “bright” and the logical “dark” regions in a respective ratio of 1:2 or in the complementary case 2:1. This means that the bright region along this section covers 1/3 and the dark region covers 2/3 of the section length, and vice versa. Preferably, this distribution along the two possible sections through the center point of the symbol, which sections run parallel to the sides, is the same. Such a symbol with the precisely two regions of the brightness distribution, which each coincide physically, is formed, in accordance with aspects of the invention, particularly by a square region with a side length of 2/3 of the side length of the symbol and by an L-shaped region with limbs of equal length which rest against two colliding sides of the square and each have the total side length of the symbol. In summary, this symbol, which is particularly preferred in accordance with aspects of the invention, therefore also has a. square base area.

Particularly these symbols having a square base area are arranged, in accordance with aspects of the invention, next to one another in a horizontal and/or vertical direction, i.e. the directions running along the sides of the symbols. In this case, the sides of the individual symbols abut one another directly and form the symbol code, the optical representation of which is also called a symbol matrix, in which the information is coded via the arrangement of the individual symbols. The symbol matrix is constructed from individual data cells, the size and geometry of which correspond precisely to the individual symbols of the two-dimensional system code. Since the individual symbols of the system code are arranged directly adjacent to one another, the symbol matrix forming the graphical representation of the symbol code also preferably has no free space between its individual data cells. By way of example, the outer shape of the symbol matrix may be rectangular or square. However, it is also possible to match the width and arrangement to the space available on a surface row by row and/or column by column.

The arrangement of the symbols in which they adjoin one another directly, i.e. an arrangement without separating characters and free spaces, produces a two-dimensional system code which is very effective in terms of surface area and which has a high information density while being extraordinarily easy to read. By way of example, the system code according to aspects of the invention can also be put to very good use in order to allow the production and quality checking of products on a production line in which individual components are assembled to form an overall product. If the components are provided with such a code at externally readable surface positions, it is possible to perform and even store automatic tracking of the individual components throughout production. This improves the quality assurance and allows systematic causes of error to be reconstructed even for problems which occur subsequently. Apart from this, the system code according to aspects of the invention can also be used for automatically controlling production cycles, as has already been described at the outset.

In addition, in accordance with aspects of the invention, the symbol code may have a plurality of symbol pairs having a complementary brightness distribution which differ in terms of their color. It is thus possible, in accordance with aspects of the invention, to provide symbols of different color in addition to the brightness distribution which has already been described in detail, as a result of which the brightness distribution has a respective associated combination of colors which can be separated from one another optically by a capture system. While coding with symbols having a complementary brightness distribution allows coding of the word length one, the use of additional colors allows multi word coding to be obtained which codes words of a length greater than one using graphical symbols. In this case, the areal arrangement of the brightness distribution is preferably the same in all symbols and the complementary symbols thereof. They differ merely in terms of their coloring. The originally binary word matrix is then regarded as a word matrix extended as appropriate by the set of possible color combinations.

A further aspect of the invention relates to a method for reading a two-dimensional system code according to a method for reading a two-dimensional system code which is constructed from a plurality of graphical symbols arranged next to one another, wherein the symbol code is formed from precisely two different symbols having the same surface area which differ in their areal brightness distribution and each code a value from a binary data word, wherein the two symbols have a complementary brightness distribution, wherein the system code has a filter applied to it which matches the brightness distribution of one of the two complementary symbols, wherein in the event of a match one symbol is recognized and in the event of no match the other symbol is recognized. The system code is constructed from a plurality of graphical symbols arranged next to one another, wherein the symbol code is formed from precisely two different symbols having the same surface area which differ in their areal brightness distribution and each code a value from a binary data word. The two symbols have a complementary brightness distribution. In accordance with aspects of the invention, the method for reading such a system code provides for the system code to have a, preferably a single, filter applied to it. The application of the filter to the symbol code is subsequently also called scanning the symbol code with a filter. Advantageously, one filter can match the brightness distribution of one of the two complementary symbols, and in the event of a match one symbol is recognized and in the event of no match the other symbol is recognized. A match or no match may also respectively mean the degree of complete match or of complete no match.

By way of example, the two-dimensional system code may be in the form of a graphical symbol matrix or a detail therefrom, as has been captured by an optical recording device.

The aim of reading is to form a binary word matrix or a binary word which reproduces the information represented or coded in the system code.

In the case of the known methods, such as the reading of MicroGlyphs, it is necessary to provide a dedicated filter for each coded bit value. In such cases, an appropriate computation operation for recognizing the symbols needs to take place multiple times when reading the system code by analyzing the graphical representation thereof, for example in a symbol matrix, and in each case local maxima for the filter responses are found and need to be compared with prescribed threshold values. In the case of excessive soiling or other damage to the symbol code, these prescribed thresholds are not reached, which means that the symbol code is sometimes interpreted as no longer being legible, even though the information per se would in fact still be evaluatable. In contrast to the reading methods—which are time-consuming as a result of the application of the multiple filters—which, as a result of threshold value comparison, also possibly reject symbol code containing information, the application of a single filter to the symbol code, in accordance with aspects of the invention, both reduces the computation time and improves the reading result, because the reading result is assigned either to one or the other symbol and hence the recognition of the symbol does not require comparison with externally stipulatable threshold values.

Uncertainties can naturally arise when an association with one or the other symbol is no certain possibility. In order to take account of the significance of the recognition of a symbol, one particularly preferred embodiment of an aspect of the invention proposes that the filter used is a correlation filter which ascertains the result of an interval function which indicates the distance of the present brightness distribution, particularly a grayscale value distribution, from the brightness distribution, particularly the grayscale value distribution, of the correlation filter. In accordance with aspects of the invention, the application of a correlation filter for reading a two-dimensional system code can also be used independently of the presence of symbols having a complementary brightness distribution, i.e. in the case of symbols which are different in the areal arrangement of the patterns. Although this usually requires the use of several different correlation filters, which would be possible, in principle, if there were sufficient computation power in the image evaluation, however, particular preference is given to the application of a single correlation filter to the complementary symbols, because low computation power and a high level of comparability of the correlation result for the various symbols is ensured for this. This also applies in the case of additionally multicolor symbol codes, since the correlation relates to the three-dimensional instances of the brightness values and the evaluation of the color can take place separately—and in a manner detached from the reading of the individual symbols.

The correlation filter corresponds to the brightness distribution of one of the two symbols and is therefore used as a correlation template. If the correlation is implemented above the symbol which corresponds exactly to the correlation template, i.e. in the brightness distribution corresponds to the symbol of the symbol code, then the result of the interval function determined for the correlation is equal to zero. If, by contrast, the same correlation template is placed over the exactly complementary symbol, the correlation result corresponds to a maximum value, since the brightness or grayscale value difference between the correlation filter and the symbol is of a maximum. The advantage of this method is that the entire surface area of the symbol is used to ascertain the correlation value, which means that no information is lost, even if portions of a symbol in the symbol code are soiled or damaged. In this case, the correlation value is between the value zero and the maximum value. However, the information is not rejected, since no comparison with a threshold value takes place in which the information is possibly eliminated as in the prior art.

In accordance with one preferred refinement of an aspect of the invention, when the correlation filter is applied, which is subsequently also called the correlation or correlation method for short, it is possible for the brightness or grayscale values situated within each symbol range to be normalized in order to improve the contrast properties of the surface adaptively and in relation to every single symbol. The effect achieved by this is that within the same symbol range there is no differentiation into further brightness or grayscale value levels, and the requisite contrast between a logically “bright” and a logically “dark” surface area is at just one brightness level. In practice, it can be assumed that technical influences of the imaging capture appliances in the recording device for depicting the symbol code mean that an abrupt brightness value change is reliably recognized for a 10% contrast difference. In accordance with aspects of the invention, the correlation method means that even a contrast of less than 10% is sufficient to reliably perform symbol associations. The normalization proposed as being advantageous in accordance with aspects of the invention also allows image preprocessing—which is applied regularly in the prior art—to be dispensed with, said image preprocessing also possibly destroying information which can still be evaluated in the raw images, depending on the application.

In accordance with aspects of the invention, such a correlation filter is intended to be applied for each symbol in the symbol code. To this end, it makes particular sense to divide the graphical symbol matrix and the correlation filter—possibly after scaling and/or orientation which can be applied to the symbol matrix and/or the correlation filter—into pixels of equal size and to move the correlation filter over the symbol matrix pixel by pixel.

Ideally, the pixel edges of the correlation filter and the pixel edges of the symbol matrix are each situated above one another after each movement step. Following each movement, the correlation method explained previously is then performed, the correlation result being able to be stored for each relative arrangement of correlation filter and symbol code or symbol matrix.

It makes sense to ascertain the correlation result following application of the correlation filter as a confidence value which can be easily processed further and stored.

The confidence value is a measure of the certainty of recognition of individual symbols at the respective positions of the correlation filter and the read symbol code. The correlation value is directly related to the interval function determined as part of the correlation, with an interval function value of zero and the maximum interval function value each signifying a high level of confidence of finding one or the other symbol in the symbol code. When an interval function value is exactly in the center, the confidence in the read symbol is equal to zero, since it is not possible to distinguish between the two symbols.

In this respect, an aspect of the invention involves a possible confidence value range between −1 and 1, the value 1 indicating a complete match with the symbol which is equal to the correlation filter and the value −1 indicating a complete match with the symbol which is complementary to the correlation filter. In addition to the measure of correct decoding of the system code, the confidence values are therefore also a measure of the graphical quality of the system matrix representing the system code.

The confidence values according to aspects of the invention have the advantage that they are directly contained in the applied correlation method in a manner in which they are determined independently of one another for all (possible) data cells and can nevertheless be derived from the application of just a single filter. Since the application of the filter is the same over the entire system matrix, i.e. the entire image of the system code, maximum comparability of the obtained confidence values among the recognized symbols is ensured. Hence, when the system code is read in line with the method proposed in accordance with aspects of the invention, it is possible to make a relatively (very) reliable statement about the certainty of recognition of the individual symbols and hence the reliability of the decoding.

It is therefore particularly advantageous, when the system code is scanned with the correlation filter, to ascertain a confidence value for each scan position and to use it to recognize the symbols in the system code.

During scanning, the center and the center pixel of the correlation filter, for example, are successively placed onto each pixel of the symbol matrix, the correlation is evaluated and the confidence value associated with the respective pixel is stored. This practice is also called template matching and allows the centers of the individual symbols to be found or located in the symbol matrix representing the symbol code at the positions having the highest and lowest confidence values. To this end, in accordance with aspects of the invention, the confidence values can be transmitted as parameters to an identification step which follows the scanning step and in which the position of the individual data cells of the symbol matrix is identified in order to determine the individual symbols in the symbol code. This identification then assigns the individual symbols of the symbol code their word significance, i.e. the binary value associated with the respective symbol. Hence, the symbol matrix is converted, in accordance with aspects of the invention, into a word matrix, the entries of which are the respective binary values. In the outer shape and arrangement of the individual entries (binary value), the word matrix thus corresponds to the symbol matrix, which has the respective symbols as entries. Prescribed rules for stringing together the individual symbols then allow the coded information to be read off from the word matrix by stringing together the individual binary words.

In this connection, it thus makes sense to provide for the most probable centers of the symbols or data cells in the symbol code or the symbol matrix to be ascertained from the confidence values.

In accordance with one advantageous refinement, the other centers of the symbols can then be explored, and the symbols thereof read, starting from at least one probable center.

Presented in summary, a preferred method, in accordance with aspects of the invention, for extracting graphical symbols from a two-dimensional symbol code involves each of the symbols recognized by filtering being allocated an independent confidence value relating to the certainty of recognition. To this end, by way of example, a grayscale value image or, more generally, an image having different brightness values which contains the depiction of the symbol matrix has a single filter applied to it which allocates such a confidence value to each of the graphical symbols used at the same time. In this case, the determination of the confidence value for a symbol is dependent solely on the location and not on encompassed results from the filter or the confidence values for adjacent symbols. Filter responses obtained at different locations can therefore be compared with one another by a metric and have an order without the individual confidence values being dependent on one another. The filter used is a normalized correlation method which determines, at each location in a grating for an image, the Euclidian interval of the brightness values, for example following conversion into grayscale values in the case of a color symbol representation, for an image detail in an environment defined by the filter operator from the template of the logical brightness distribution for a family of graphical symbols. In accordance with aspects of the invention, ascertained confidence values can be forwarded as parameters to a subsequent process step, with these confidence values then being used for sorting or selecting the corresponding words.

In accordance with aspects of the invention, it is additionally possible to evaluate the color of the symbols. Hence, a color or color combination can be assigned to a word, i.e. a binary value. It is therefore possible for the originally purely binary symbol significance to be assigned further significance which allows multidimensional multiword coding. If the original symbols are regarded as a binary word matrix, this is then regarded as a word matrix extended as appropriate by the set of possible colors or color combinations. In this case, nothing about the evaluation of the brightness distribution changes, since it is also possible to capture the different brightnesses of the individual colors. This can be done either immediately on the basis of the color representation or after conversion into grayscale values.

As part of the decoding, it is then preferably also possible to ascertain a confidence value for a color distribution for the symbols. By way of example, it is possible to determine the averaged interval of the color values for all pixels associated with a graphical symbol from the color distribution of the template thereof proportionately to the confidence value ascertained in relation to the brightness distribution of the symbols in the system code in comparison with the correlation filter. It is even conceivable to connect the two ascertained confidence values to produce a single confidence value. To this end, it is possible to use what is known as the “CIE 1976 u′, v′ color space” for the color distribution of the template and also of the image detail which corresponds to the filter operator. Hence, it is possible to determine the Euclidian interval between template and image detail which results in an extended confidence value. Alternatively, the RGB color image obtained from a sensor, which is a vector image, can be broken down into an absolute value image (of the color vectors) and into a corresponding direction image (of the color vectors). The absolute value image obtained in this manner is equivalent to a brightness or grayscale value image obtained from a sensor, so that the same analysis and correlation method as previously can be applied thereto. For symbol regions which have been recognized, the color distribution in the corresponding RGB direction image can then be determined by means of Euclidian interval measurement in relation to the templates of possible color distributions.

In accordance with one application-oriented further development of an aspect of the invention, the time profile of the confidence values in a region of the system code can be evaluated. This is possible in automated production installations, for example, in which the components or general objects are provided with the two-dimensional system code according to aspects of the invention. A general or local drop in the confidence values indicates increasing soiling or damage for an object in the entire or a restricted region of the graphical symbol matrix. A drop in quality or a functional error in the printing technique used likewise produces such a pattern with confidence values dropping over time.

Confidence values ascertained at one time are stored and/or updated in a database on the basis of object, capture station and time. Confidence values ascertained in the future are then compared with this database and assessed. If the threshold value for a statistical evaluation, for example within the context of a histogram metric, has been exceeded then the currently measured confidence values differ from the norm. An expert then ascertains and eliminates the cause of the indicated fault. Hence, the system for producing and reading a two-dimensional system code can also operate internal quality assurance and can monitor itself. The confidence values provided in accordance with aspects of the invention therefore allow an information system formed by the proposed two-dimensional system code to be monitored in production installations, for example, and errors to be eliminated before such a system fails.

In order to match the filter used and the depiction of the system code to one another, it is possible, in accordance with aspects of the invention for the filter which corresponds to a representation of one of the two symbols of the symbol code and the symbol code which is to be read, i.e. particularly the representation of the symbol code in the symbol matrix, as has been captured by an optical reading system, to be mapped onto one another by a mapping method which contains scaling and/or rotation, in particular.

In addition, a further parameter of the method may be a set of possible characterizing shapes for expected symbol matrixes. Each of the indicated shapes needs to differ sufficiently from every other instance of the shapes contained in the set, so that explicit association of an indicated shape with the current symbol matrix is possible. The current shape of the symbol matrix in the image detail creates a translation-invariant surface area histogram. This surface area histogram is compared, using a metric, with the corresponding surface area histograms from the given set of characterizing shapes of symbol matrixes, and the symbol matrix from the surface area histogram which is closest within the context of the defined metric is selected. The word matrix determined as corresponding to the symbol matrix from the image detail is that word matrix which corresponds to the selected characteristic shape of the indicated set. The symbol matrix from the current image detail is converted into this word matrix.

It is also possible to derive scaling and rotation parameters solely from the confidence values or at least to some extent from a superordinate pattern which is obtained as a result of the arrangement of the symbols within a symbol matrix, such as parallel and orthogonal line segments. Superordinate patterns can cause a preferential direction for the gradients in a brightness value image. The preferential direction is then extracted from the derivation of the brightness value image in the X and Y directions, by applying the Hough transformation, a Radon transformation or by applying controllable filters.

In accordance with the use of a two-dimensional system code which has been applied to components of a product in an automated production line and has information for denoting the components and/or for controlling the production flow, wherein the system code is captured by readers positioned on the production line and is evaluated by a superordinate control system. An aspect of the invention also relates to a preferred use of the two-dimensional system code described previously which has been applied to components of a product on an automated production line as part of direct product marking (DPM), by fitting tags or the like printed with the system code, and has information for identifying the components and/or for controlling the production flow. In this case, the system code is captured by readers positioned on the production line and is evaluated by a superordinate control system. For this, the system code proposed according to aspects of the invention affords the advantage that the symbols used in the system code are very robust toward damage and soiling and that it is also a simple matter to achieve a high level of redundancy for the data, since the system code makes very effective use of the available surface area in comparison with known two-dimensional system codes. Evaluation using confidence values allows very reliable read results, although it is possible to dispense with frames, synchronization characters and other special characters. The effective surface area utilization also allows the desired information to be accommodated on very small surface areas of the components.

A two-dimensional graphical symbol code which is used for this purpose and which, on account of the properties which have been described previously overall, is very easily and reliably machine-readable can, in accordance with aspects of the invention, usually contain details about the specific type, an identification number, a model descriptor, possibly details about the production process, such as production location and time, batch number, of the technical processing and/or further information. A component or object can therefore describe itself using the data coded in its machine-readable marking and can thus contribute to the (semi)autonomous control of the production installation. However, this detailed information about the object cannot be used to control the production installation. In the event of damage occurring when a finally assembled product is used, it is possible—for example when storing the information collected during production and related to the symbol code—for there to be additional details available for each marked object up to component level, said additional details describing quality features associated specifically with this object or properties of the technical processing processes performed on this object. This may help to reconstruct the course of events for the accident or else can support the legal clarification of recourse demands. Furthermore, this assists in finding systematic errors in the production line.

Finally, an aspect of the invention relates to an apparatus for reading a two-dimensional system code having an optical recording device and an evaluation device having a processor which is set up to process the optical signals delivered by the recording device and to decode the two-dimensional symbol code. The processor of the evaluation device has the previously described method or portions thereof implemented in it by means of suitable software. The evaluation device may be integrated in the reading apparatus with the optical system or may be a computer system, particularly in the form of a computer or a plurality of networked computers to which one or preferably a plurality of recording devices are connected.

Before specific exemplary embodiments of aspects of the invention are described with reference to the drawing, light will be shed on advantageous aspects of the invention which are each part of the invention separately and independently of other aspects.

In accordance with a fundamental principle which is essential to aspects of the invention, the brightness distribution of a symbol is used as a basis for the distinguishability.

The graphical symbols of the symbol code for a one-word and a zero-word, which need to be distinguished for binary data coding, are chosen in aspects of the invention such that maximum distinguishability is ensured. The system code contains the graphical symbols within tiled data cells in a basically arbitrarily shaped symbol matrix. In this case, the symbols fill the data cells completely. A data cell can thus be interpreted as a pixel image in which a graphical symbol is portrayed.

In accordance with aspects of the invention, the two graphical symbols are distinguished by their particularly complementary brightness distribution. Machined surface areas of a data cell are represented logically by black pixels, i.e. logically dark, and unmachined surface areas of a data cell are represented logically by white pixels, i.e. logically bright. On the basis of the material or the surface on which the symbol code has been applied and the imaging capture technique of the recording device in a reading apparatus, it is possibly additionally necessary to specify whether the logical brightnesses correlate to the brightness values which are actually present in the image. This is because on the basis of the type and composition of the carrier material and the method of applying and reading a graphical marking, the machined object surface area may appear either darker or else brighter in the image to be analyzed than the unmachined surface area. Since the association between the symbols and the word is based specifically on complementary brightness and, when only one of the graphical symbols is considered on its own, it is not possible to make a decision about what brightnesses can now be attributed to the object background (as logically bright surface area of the symbol) and what brightnesses can be attributed to the machined surface area (as logically dark surface area of the symbol), prior static initialization of the associations is necessary. Alternatively, a defined symbol can also be provided in the symbol code for dynamic recognition.

To this end, the coding and application processes and also, accordingly, the recognition and decoding processes are considered separately from one another, with both the application and reading methods and the application material and the physical condition thereof being taken into account. In accordance with aspects of the invention, matching can be performed by virtue of a scaling factor which is applied in the method and which reverses the binary word associated with a graphical symbol. In accordance with aspects of the invention, this allows the logically bright symbol to be consistently always associated with the optical captured bright symbol. A corresponding situation applies for the dark symbol.

A high data density can be achieved by virtue of the individual graphical symbols being square and therefore compact. These symbols can be fitted directly into the cells which result from the logical matrix-like arrangement according to columns and rows. In this case, the surface area of such a data cell can be filled completely with the graphical symbol, so that symbols in adjacent data cells merge directly into one another. This achieves increased reliability for the later recognition of these graphical symbols, since even brightnesses of the pixels in the edge region of a data cell can be associated with a symbol and can also be involved in the decision-making regarding which graphical symbol is shown in a data cell.

In the graphical symbol matrix resulting from the tiled arrangement of data cells, it is thus not necessary to leave additional free space between adjacent data cells. Such free space also does not need to be produced, for example by preprocessing filters, for separating the graphical symbols in the image analysis. Thus, valuable brightness and grayscale value information is also preserved in the edge regions of the data cells.

This possibility of arranging the graphical symbols with their data cells completely filled is an important reason for the compactness and the achievable data density, since in this way, even when a data cell has small square dimensions of, by way of example, even just six pixels in the captured image, it is possible to ensure a distinction certainty which corresponds to that of any larger-scaled data cell.

In accordance with one particular aspect of the invention, the graphical symbols for a one-word and a zero-word may have a specific logical brightness distribution which is optimized for use in the DPM (direct part marking) methods. In the figures of this application, regions at which the carrier object is machined using application technology are identified in black, for example. In the case of the cited DPM method, a laser is usually used to machine a surface area of the carrier material (i.e. the region selected for marking on a component) by removing a thin layer in the micron or nanometer range. In this context, a distinction is drawn between dot-based and vector-oriented techniques.

In the case of dot lasering, a surface area is divided into a grating. Standard products achieve a resolution of between 800 dpi and 1200 dpi. Individual dots are then lasered as a pulse. By way of example, a dot size corresponds to a region on the object which is 0.15 micron in diameter. This method is very time-consuming, which means that burning a square matrix code with the dimension 0.5 mm at 800 dpi resolution takes over twenty seconds. In production practice, such time is usually unavailable.

By contrast, a vector-oriented method operates “without removal”, which is why lines and surface areas can be burned quickly. For the example above, only three to five seconds of time are required, for example, which, depending on the laser and the required power, can also be significantly lower. In order to achieve short clock times in production, the use of a vector-oriented method therefore makes sense. For this reason, the individual symbols are designed, in accordance with aspects of the invention, such that vector-oriented drawing of these symbols is possible. In accordance with one preferred embodiment, they therefore each contain only two cohesive surface areas, of which, in accordance with aspects of the invention, one surface area needs to be machined and the other surface area remains unmachined. A symbol can therefore be drawn in one move without removing the laser.

A further criterion for the selection of the graphical symbols is a technical restriction in the process of lasering. The edges between machined and unmachined surface areas are not clear-cut, since powder traces produced during burning react with the material in the surroundings or the movement of the laser does not run exactly and thus additional regions are machined which are not intended to be. In this case, machined regions can erode and merge continuously into unmachined object regions, or the majority of the latter can even be covered by surrounding machined regions—referred to as overlay—since burning has taken place beyond the separating edge. This effect is intensified in the case of cambered or curved surfaces because the laser usually cannot be positioned ideally at right angles to the surface of the object at every point for technical reasons and with a feasible level of involvement. There is therefore a shallow angle between the surface and the laser beam, so that the material is likewise removed in the vicinity of the desired point of impingement on the object surface. This effect can be reduced if the laser is mounted in an apparatus which travels around a cylindrical object, for example, so that the angle of impingement of the laser beam is always as right-angled as possible. This is a complex, error-prone, time-consuming and difficult-to-calibrate process, however, which means that, in accordance with aspects of the invention, a brightness distribution which is defined more precisely later is preferred which can largely compensate for the effect of such errors in the complementary brightness arrangement.

Although the application technique using a laser has been analyzed in detail above, analogies to the cited problems can also be transferred to other techniques, particularly printing techniques. The symbol shape chosen as a preference in accordance with aspects of the invention allows additional robustness toward these influences, so that the recognition is reliable even when application is not exact.

A criterion which is suitable in accordance with aspects of the invention for the setup of the brightness distribution may be that an unmachined surface area having the logically bright feature is not entirely surrounded by the machined surface area having the logically dark feature in order to prevent or reduce overlay. This is achieved in the case of the symbol which is particularly preferred in accordance with aspects of the invention and which is explained in detail in the description of the figures even when a symbol in an eight-neighborhood is surrounded entirely without free space by any other symbols. In accordance with aspects of the invention, it is also not possible for machined and unmachined surface areas to be mapped onto one another, which further increases the distinction capability.

In order to prevent damage to the component, it is frequently only possible for the lasering to involve operation or burning at a maximum permissible power, which is why the machining is more or less clearly visible, depending on the material surface. Achievable contrast differences in this case are typically 70% or above. The contrast properties are also dependent on the respective surface material and may even differ within a marked region, so that different symbols from the same symbol matrix have different contrast properties. Changes in the contrast can also stem from erroneous adjustment of other parameters of the hardware for application. The perfect setting of such parameters is time-consuming and they can change over time. Therefore, an aspect of the invention proposes a particularly robust symbol code which is achieved to a great extent simply by using two areal symbols having a brightness distribution, i.e. at least two different brightnesses in the symbol surface area, with the brightness distribution of the symbols being exactly complementary with respect to one another. Even if, in the present application, only two respective different brightnesses are described in specific examples, aspects of the invention may involve each symbol also containing more different brightness values which can be transferred to the complementary symbol by means of complementary grayscale value levels, for example.

Symbols should also be robust toward damage by scratches, soiling or errors in the application, for example when a symbol has not been applied completely. This invention therefore defines preferred graphical symbols for zero-words and one-words, which in every case have a region which requires the object to be machined. It is thus possible to additionally reduce erroneous associations which are caused by soiling on entirely unmachined surfaces or conversely by reflections on entirely machined symbol surface areas.

One preferred symbol shape from an aspect of the invention provides a particular ratio for machined to unmachined symbol regions. If the symbols used as a preference are regarded as a pixel image and each symbol is grated with a 3×3 grid, the ratio of machined symbol region (5/9) to unmachined symbol region (4/9), or vice versa, is almost 1:1, which means that both components are represented to approximately the same extent. The discrepancies are in a region less than or equal to 1/9 of the total surface area, which in practical attempts has been found to be a useful limit for discrepancies. In particular, a 3×3 grid of individual symbol pixels sets up a useful equilibrium between the sizes of the symbol, which should not be chosen to be too large to allow a high achievable surface area density and should not chosen to be too small to allow good legibility. The pixel size of a signal theoretically allows an approach to the resolution limit of the application or reading method.

A further important criterion for the symbol size is naturally the space available on the surface to be marked which can be utilized in accordance with aspects of the invention. The symbol size can then be chosen to be precisely the size which allows the desired information to be coded.

If respective consideration is given both to only the one-dimensional X axis and to the one-dimensional Y axis of the two-dimensional symbol, which in the preferred example each run along the symbol edges of the rectangular or square symbol, an aspect of the invention allows a preferred ratio of 1:3 or of 2:3 to be observed for machined to unmachined symbol regions.

When a brightness is issued in a manner which is preferred in accordance with aspects of the invention, the symbols for the zero-word and the symbols for the one-word thus each have an—on average—almost equal distribution of brightness values, so that neither of the two symbols is given an advantage in the recognition by virtue of one being marked more conspicuously in comparison with the other. On the other hand, in the image processing for one-dimensional analysis of the brightness value image of a symbol code on the basis of abrupt changes in brightness value, it is possible for a response pattern that can be explicitly distinguished to be produced, even if the application quality is inadequate, since both regions are at a broad interval from one another.

The particular advantages of the system code proposed according to aspects of the invention also come particularly to light in the reading and decoding methods according to aspects of the invention by virtue of the recognition and decoding of the individual symbols in the symbol matrix which presents the symbol code preferably involving the use of a correlation method which has been unusual for this purpose in the prior art to date, even regardless of the use of symbols with complementary brightness use.

In a correlation method which is preferred in accordance with aspects of the invention, brightness or grayscale values are normalized within each individual symbol region in order to optimize the contrast properties of a surface adaptively and in a manner limited to a single symbol. Thus, the problem of reflections at reflected surfaces can also be tackled.

The contrast, required for the method proposed according to aspects of the invention, between bright and dark surface areas of a symbol is at only one brightness value level. To allow optimum distinction, there should then be no further difference in brightness value levels among the brightness values within the same surface area. Since current imaging capture appliances involve a need to take account of construction-related technical influences such as image noise, homogenous surface areas having the same brightness will not be available as the very same in the pixel image. In accordance with aspects of the invention, it can be assumed that an abrupt brightness or grayscale value change at a contrast difference of 10% will be reliably recognized. The actually required contrast difference can be lowered further if the correlation method is robust toward outliers, so that, in the case of the reading method according to aspects of the invention, a contrast of less than 10% is even sufficient in order to perform the symbol associations reliably. Since the proposed method also requires no preprocessing in the image processing, this means that no further brightness value errors are interspersed, so that the requisite contrast difference can be quantified as above.

To date, correlation methods have not been used in the image analysis for the purpose of extracting symbol codes where possible in practice, since a correlation method is very computation-intensive in comparison with morphological operators. The present invention eliminates this alleged drawback on account of the choice of two graphical symbols having complementary brightness distribution, because when the image to be analyzed which represents the symbol code is filtered with just a single correlation filter, both symbols can be located at the same time. In this regard, the result of an interval function is calculated for the filter template which matches the brightness distribution of one of the symbols which are complementary in accordance with aspects of the invention. The interval function thus indicates the distance of the present grayscale value distribution from the grayscale value distribution of the correlation template.

If the correlation is performed over a symbol which corresponds exactly to that of the correlation template, the result of the interval function is equal to zero, since there is no difference. If the same correlation template is placed over the exactly complementary symbol, however, then the correlation result corresponds to a maximum value, since the grayscale value difference for each image pixel is at a maximum.

By contrast, the methods which are customary in the prior art involve the definition of graphical symbols, the shape of which has features which are associated with a word. In order to decode a word length n, 2ⁿ filters are therefore usually applied to the image to be analyzed, said filters having a high degree of match with one of the possible symbol types and having the smallest possible degree of match with all other of the 2ⁿ symbol types, in order to be able to allocate an explicit value to a particular symbol.

In order to decode a binary word, two filter operations are therefore necessary on the basis of the process which is customary in the prior art. An aspect of the invention therefore firstly allows the number of filter operations to be reduced by half, so that the binary words require only one filter operation to be performed. Secondly, when a correlation method according to aspects of the invention is applied, image preprocessing is unnecessary before the filters are applied, which means that in this case the computation time can be reduced further in comparison with the prior art. Both properties help to reduce the execution time.

Nevertheless, the reliability of the method according to aspects of the invention is higher than when morphological filters are applied, since each pixel is considered and no information is lost, for example as a result of binarization methods or methods for separating adjacent graphical symbols. Both make the preferably proposed application of a correlation method according to aspects of the invention for the efficient and reliable recognition of two-dimensional machine-readable codes in process control with short required clock times competitive and superior.

In accordance with a further aspect of the invention, it is possible to ascertain confidence values for determining the certainty of recognition of a, preferably each, symbol while the individual symbols of a symbol code are being read or decoded.

In this refinement, the proposed method for recognizing graphical symbols can immediately indicate how certainly it can associate the recognized symbol. This is particularly advantageous with redundant coding of words, because in that case, on the basis of the certainty of recognition of individual symbols, it is possible to determine a set of symbols with a high degree of recognition certainty for reconstructing the coded word. In the case of the method according to aspects of the invention, such values can be requested for each recognized symbol. These are called a confidence value. They are directly included in the applied correlation method, specifically such that all confidence values for all symbols are determined independently of one another and are nevertheless derived only from a single filter operation. In this case, the filtering is the same at each location in the image, as a result of which maximum comparability of the confidence values obtained among the recognized symbols is ensured. Therefore, application of the method according to aspects of the invention allows not only decoding but also, at the same time, a statement about the decoding quality.

The simple and robust design of the individual symbols in the symbol code means that, in accordance with aspects of the invention, no symbols are required for synchronization in the symbol code. On the contrary, the symbol code can be formed exclusively from the two complementary symbols. It helps, to increase the data density and the reliability of recognition, that the system code according to aspects of the invention preferably contains no special symbols for localization, equalization or synchronization and also contains no statically stipulated sequences of symbols or predefined regions which are used for version or format definitions. Firstly, the omission of anchor symbols or static patterns means that there is more space available for data information, and secondly a “single point of failure” is eliminated. This is because if the pattern for synchronization, an anchor symbol or the version description cannot be extracted correctly, for example on account of reflective surfaces or soiling, this prevents decoding of the symbol matrix completely.

Previous markings in the prior art were often limited to a rectangular symbol matrix or a circular shape for the arrangement with a particular minimum size in order to accommodate not only the symbols for the data bits but also synchronization objects. This prevents arbitrary arrangement on small components, on surface areas with cutouts, or the splitting of the symbol code and application thereof to surface areas which are separate from one another. In accordance with aspects of the invention, following the static initialization of an arbitrary polygonal free shape, the graphical symbols can be explored and transformed into a suitable word matrix. Alternatively, it is possible to indicate an arbitrary set of surface areas for application which differ in shape and within which the graphical symbols are arranged in tiled data cells. During the exploration of the symbols, the most probable shape characterizing the symbol matrix is selected and accordingly the word matrix is produced.

The proposed method is preferably parameterless in the sense that the input expected for the algorithm is a brightness image or grayscale value image which contains a depiction of the symbol code defined here. In this case, all required parameters for the symbol code, such as scaling, translation, rotation and surface area for application, can be ascertained in accordance with aspects of the invention by the method itself. It is therefore not necessary to adjust the parameters when starting up a visual capture station. This holds great advantages, since making such settings manually is complex and would not allow recalibration to be avoided even in the case of minimum changes to the overall system. The adaptive orientation of the method according to aspects of the invention allows the calibration to take place automatically, as will be explained later with reference to an example.

The graphical symbol code proposed in accordance with aspects of the invention eliminates—as a result of its adjustable shape, the robustness of the chosen symbol types and shapes and the both reliable and computation-efficient extraction method (decoding)—restrictions which currently still exist in DPM (direct part marking) methods for applying two-dimensional system code, particularly for applications involving small components with reflective surfaces. For the selection and development of the graphical symbols and the extraction method for this symbol code, typical and contrary demands placed on such a system code in automated production have been taken into account. The aim is to develop further and miniaturize electronic and mechanical components. If these objects are intended to be provided with a machine-readable, two-dimensional symbol code, it is necessary for such codes to be available as can also be applied when the available surface area is small and as afford a high level of data density with additional error correction. The reading is intended to be possible reliably and efficiently, so that clock times on the production line can be increased further.

This invention now provides such a system code and a method attuned thereto for producing and/or reading the symbol code which are used to extend the options for DPM (direct part marking) and to make techniques such as prior roughening of the object background or the attachment of paper tags obsolete.

One particular advantage of an aspect of the invention is the quality control as a result of generally falling confidence values, which are independent of one another, because they follow directly from the application of a filter to the symbol code, which is constructed particularly from complementary symbols.

The proposed imaging method for decoding the symbol matrix representing the symbol code into a word matrix outputs the associated confidence values, in accordance with aspects of the invention, whenever a symbol is recognized. Such confidence values can be averaged over a large number of chronologically successive decoding operations by the same checking station, so that over time generally falling confidence values provide indications of increasing soiling to the objects. Falling confidence values can be established on an entire symbol matrix or else only on subregions of a symbol matrix, since the confidence values can also be stored with local resolution in accordance with the arrangement of the data cells in the symbol matrix. In the event of increasing soiling, the cause can be sought and eliminated in the production process before it has increased to such an extent that symbol codes are no longer able to be decoded, for example. Falling confidence values can also stem from local burning errors by the laser when the symbol code is applied, or from unnoticed changes in the composition of the surface material, or other wear. Observation of the confidence values through storage, processing and alignment in a database allows early consideration of impairment of the processing quality.

A further advantage of an aspect of the invention is that the binary coding by two symbols of complementary brightness distribution can easily be extended to multiword coding by using colored graphical symbols, without the need to change the evaluation method. As additional information, it is merely necessary to recognize the color as well.

Within the context of this application, the coding of the word length one, i.e. binary coding, is handled extensively by graphical symbols. It is easy to derive multiword coding which codes words of a length greater than one using graphical symbols. This can be achieved with a printing technique which supports color. In this case, the graphical symbols are printed in color, so that the black and white brightness distribution (grayscale value distribution) is assigned a respective combination of colors. It is possible to use any number of colors if they can be reliably distinguished from one another. The optical system captures the colored symbol code, for example as an RGB color image. The color image can then be transformed into a brightness channel, i.e. a grayscale value image, and further color channels. The brightness channel is thus processed as already described previously for grayscale value images. Next, the color information from the color channels can then be added from the extracted symbol cells, and the analysis result therefrom is also included in the word matrix before this is output.

On the basis of the brightness distributions for the graphical symbols for coding a word length of one, it is possible to count which pixels have their expected color information, specifically separately according to the bright and dark regions of a symbol. Soiled regions do not have the desired color information, which means that pixels in these regions would not be included. From the number obtained, it is possible to calculate a confidence value for the color information as a ratio to the actually expected maximum number of pixels with one color.

Thus, the word matrix can be augmented with an expanded word length and associated additional confidence values to produce the color information before it is output to the decoding method. If care is taken during the color selection to ensure that from the captured brightnesses it is solely possible to associate the graphical symbols based on complementary brightness with the single-word coding, without using the additionally provided color information, encoding can take place such that a comprehensive binary data record is split into a portion which can be decoded from a grayscale value image alone independently of the additional color information and into another portion which can be decoded only when color information is available and which holds additional information which is not absolutely necessary.

In similar fashion to the previously described color coding, an aspect of the invention also allows symbol codes which are invisible to human vision to be embedded into a color image, for example for the purpose of cryptographical signature. Humans assess a color value which is very close to another color value as the same. This effect is quantified by what are known as MacAdam ellipses. The CIE U′, V′ color space projects these ellipses approximately onto circles which can be placed around a color value. If local regions have a similar color value in a color image, this can be regarded as the center of a MacAdam Ellipse. If a graphical symbol from the symbol code is now placed in this region, the region drawn in black at that point is assigned a color value at the edge of the MacAdam Ellipse, and the region drawn in white has a color value which is opposite on the MacAdam Ellipse set for it. In order to perform one-word decoding of the graphical symbols of the symbol matrix, only brightness values are of interest. Since color values can be ignored, each symbol can have different color values which respectively match the background of the color image on which the symbol code is applied. So as not to destroy edges of regions in the color image, it is not absolutely necessary to place a graphical symbol at these points. If a high-resolution optical capture system with homogenous distribution of light is available, such a symbol code can be decoded. This continues to be invisible to a human observing the color image, however.

Further advantages, features and possible applications for aspects of the invention can also be found in the description of exemplary embodiments below and in the drawing. In this context, all features described and/or shown graphically form the subject matter of the present invention on their own or in any combination, including irrespective of their synopsis in the claims or back-references therein.

### BRIEF DESCRIPTION OF THE DRAWINGS

The invention is best understood from the following detailed description when read in connection with the accompanying drawings. Included in the drawings is the following figures:

FIG. 1 shows an exemplary embodiment of the brightness distribution of the graphical symbols for a zero-word (depiction a) and a one-word (depiction b) which can preferably be used in binary coding. The thin boundary lines drawn are not part of the respective symbols but rather serve to illustrate the physical limits thereof.

FIG. 2 shows a flowchart for the procedure for selecting, attaching and capturing an optimum symbol code according to aspects of the invention under ancillary conditions.

FIG. 3 shows a flowchart for the inventive incorporation of the symbol code for automating production.

FIG. 4 shows a flowchart for the embedding of a checking or assembly station with recognition and processing of a symbol code according to aspects of the invention on an object.

FIG. 5 shows the schematic flow of the recognition in an application example according to aspects of the invention in which the symbol code has been attached to a cylindrically curved surface with reflective properties.

FIG. 6 shows the schematic flow of the recognition in an application example according to aspects of the invention in which a plurality of symbol codes on valve heads in a small control valve with a curved and flat, reflective and matt surface and also of different height are read, in accordance with aspects of the invention, by a single recognition station from a single captured image.

FIG. 7 shows a flowchart for a method according to aspects of the invention for producing and associating various symbol codes, which can be distinguished by the inner and outer shapes of their surface area for application, with the captured graphical symbols in the image which is currently to be evaluated.

FIG. 8 shows a first embodiment of a symbol matrix, representing the symbol code, in a rectangular surface area for application comprising 21 rows and 30 columns of individual data cells with a symbol arranged in each data cell, as shown in FIG. 1.

FIG. 9 shows a second embodiment of a symbol matrix, representing the symbol code, in a grated circular surface area for application.

FIG. 10 shows a third embodiment of a symbol matrix, representing the symbol code, in a grated circular surface area for application with a central cutout.

FIG. 11 shows a fourth embodiment of a symbol matrix, representing the symbol code, as a free-form surface area in a polygonal surface area for application. For the purpose of illustration, the outer shape is additionally shown in approximately rendering boundary lines for the symbol matrix which are not part of the symbol code, however.

FIG. 12 shows an illustration of the symbol centers—reproduced as a dot—of the individual symbols in the data cells in the symbol matrix in the fourth embodiment shown in FIG. 11. This highlights the row-like and column-like matrix-like arrangement of the symbols within the free-form surface area, the edges of which can vary from row to row and column to column, however, and may possibly even be interrupted.

FIG. 13 shows a fifth embodiment of a symbol matrix, representing the symbol code, comprising two free-form surface areas which are separate from one another and have a respective dedicated polygonal surface area for application. For the purpose of illustration, appropriate boundary lines are again additionally shown which approximately render the outer shape of the symbol matrix, but are not part of the symbol code.

FIG. 14 shows an illustration of the symbol centers—rendered as a dot—of the individual symbols in the data cells in the symbol matrix in the fifth embodiment shown in FIG. 13. This highlights the row-like and column-like matrix-like arrangement of the symbols within the free-form surface area, which in this embodiment extends to both the free-form surface areas.

FIG. 15 shows an illustration of a surface area histogram for the symbol matrix shown in

FIG. 13, the geometric focal point of which is denoted by a cross. The surface area histogram indicates whether or not a symbol represented by a symbol center is situated in a surface area histogram cell. In this case, the surface area histogram cell has the value 1, otherwise it has the value 0.

FIG. 16 shows a flowchart with an overview of the general method steps for inventive transformation of the graphical symbol matrix into its corresponding word matrix, including ascertainment of confidence values.

FIG. 17 shows the graphical symbols for the zero-word (depiction a) and the one-word (depiction b) with additionally shown scaling information for the purpose of illustration. In this context, it becomes clear that a graphical symbol is classified into 3×3 pixels blocks having square side lengths of approximately the same size. The main feature in this case occupies a condensed 2×2 pixel block at the bottom right in the graphical symbols a and b. the rest of the region is obtained as a linear surface area arranged at right angles which has been pulled in the width of a 1×1 pixel block, around the two abutting sides of the outer edge of the main feature. In the illustration chosen in this case, the linear surface area runs from the bottom left to the top right in both embodiments shown in depictions a and b. Hence, in depiction a, a size ratio of 1/3 to 2/3 is obtained between the machined (logically black) and unmachined (logically white) regions in any direction along the lateral edges. Since the symbols shown in depictions a and b have a complementary brightness distribution relative to one another, the aforementioned ratio between machined and unmachined regions in depiction b is exactly the opposite.

FIG. 18 shows an embodiment of a dual template (also called dual symbol templates or double symbol templates) for the two symbols from the system code, which dual template can be used for extracting explicit rotation and scaling parameters. The invention is not limited to the dual template in the example. However, it is advantageous if, in accordance with aspects of the invention, embodiments of both the zero-word symbol and the one-word symbol are covered in the dual or multiple template. Using a dual or multiple template, ambiguities are resolved in the 0°, 90°, 180° and 270° rotations.

FIG. 19 shows the graphical result of initially testing various automatically generated dual templates for the purpose of ascertaining scaling and rotation parameters. The initial testing involved the respective dual templates rendered to the right next to the illustration with confidence value represented by dots of different size being applied to the pixels of the image in the symbol matrix in depiction a, i.e. the image was scanned pixel by pixel for matches between the system code shown in the image and the dual template. To this end, the dual template was shifted relatively over the image to be evaluated, and the congruence of the dual template and the image was determined. This process is also called correlation. The result of such determination is confidence values. The depiction a in FIG. 19 shows the image detail to be examined with a rotated symbol matrix. Depictions b, c, d and e each show dual templates which are generated by way of example according to specifications and which differ in terms of their size and orientation relative to the symbol matrix. The respective correlation results are shown for all pixels to the left next to the dual templates which are respectively used for the correlation, with thicker dots signifying a higher level of confidence. In practice, centers of the double symbol template which are possible outside of the symbol matrix are also extracted, which can be caused by surface structure effects. Dual templates which are a long way from the actual parameters, as in depictions b and c, have generally lower confidence values for the correlation. The dual templates shown in depictions d and e result in high confidence values, with the exactly scaled and oriented dual template shown in depiction e producing the highest confidence values, specifically precisely at the positions in the image at which such a symbol is present in the symbol matrix shown in depiction a.

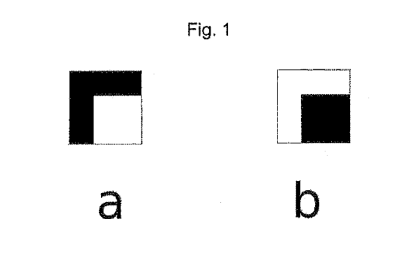

FIG. 20 shows, in depiction a and in depicture b, a respective four-neighborhood comprising cells of zero-word symbols. The illustration in depiction b corresponds to that in depiction a after a rotation through 90° in a clockwise direction. It can be seen that depiction b shows a pattern which now shows only two complete zero-word symbols in the orientation shown in FIG. 1.

FIG. 21 graphically explains a partially valid scaling invariance. If a symbol is correlated to a relatively small symbol template, in the best case an X- or Y-axis-based ratio of approximately 1/2 for machined to unmachined symbol regions is achieved, which does not correspond to the original ratio of 1/3 or 2/3. However, taking account of the fact that correlation values as a result of the incorrect ratio are lower by a constant factor than otherwise, the correlation can allow explicit association in accordance with aspects of the invention.

FIG. 22 shows a square symbol matrix after filtering with a Sobel filter mask (edge detector) in the Y direction of the image axes. Using a Hough transformation, the gradient value of the straight lines can be extracted and hence an estimate of the rotation of the symbol matrix can be provided.

FIG. 23 shows a method according to aspects of the invention for the accelerated initial testing of the image orientation of the symbol matrix using a Hough transformation by way of explanation. In this case, rotation parameters are approximated by the primary orientation of the line segments of the individual graphical symbols. Depiction a shows an image detail with a rotated symbol matrix. By applying an edge detector for grayscale value edges, such as the Sobel operator in the direction of the X and Y axis sections, an image as shown in depiction b is obtained. The extracted line segments can be fused by means of a Hough transformation to form parameterized straight lines, as shown in depiction c. On account of the matrix-like arrangement of the graphical symbols, two mutually orthogonal main directions of straight lines are therefore obtained. The parameterized straight lines prescribe the two possible rotations and the two preferred rotations that are to be initially tested by means of the dual template. For each rotation, there is corresponding reflection thereof, so that a total of four degrees of freedom continue to exist which are initially tested by means of the dual template. This is shown in depictions d, e, f and g. Initialization for the scaling parameters can be obtained in accordance with aspects of the invention from the parallel straight line intervals from depiction c.

FIG. 24 shows a flowchart for finding the centers of the symbols and for the subsequent exploration of these centers in consideration of center data containing noise as a result of the image processing.

FIG. 25 shows a correlation image for the symbol matrix shown in FIG. 11, where only the correlation results for the zero-word have been highlighted. In this drawing, the density of the dot distribution indicates the correlation values. A high density signifies a correlation value of close to 1.0 and a low density signifies a correlation value close to −1.0. This is representation-dependent; the real algorithm has a grayscale value distribution available. For the purpose of highlighting, the surface area for application is additionally shown.

FIG. 26 shows a correlation image for the symbol matrix shown in FIG. 11, where only the correlation results for the one-word are highlighted. In this drawing, the density of the dot distribution indicates the correlation values. A high density signifies a correlation value of close to 1.0 and a low density signifies a correlation value close to −1.0. This is representation-dependent; the real algorithm has a grayscale value distribution available. For the purpose of highlighting, the surface area for application is additionally shown.

FIG. 27 shows a correlation image as an absolute value image for the symbol matrix shown in FIG. 11, where the correlations for the zero-word and for the one-word have been highlighted. In this drawing, the density of the dot distribution indicates the correlation values. A high density signifies a correlation value of close to 1.0 or −1.0 and a low density signifies a correlation value close to 0.0. In the latter case, no symbol has thus been able to be identified. This is representation-dependent; the real algorithm has a grayscale value distribution available. For the purpose of highlighting, the surface area for application is additionally shown.

FIG. 28 shows a dilatation image based on FIG. 27 in which the density of the line segments indicates the confidence for a symbol in this local region. This is representation-dependent; the real algorithm has a grayscale value distribution available. For the purpose of highlighting, the surface area for application is additionally shown.

FIG. 29 shows a noisy center image for a square symbol matrix on a curved surface, wherein the extracted symbol centers are shown in black. Centers are also marked on an unmachined object background. Within the symbol matrix, not all the centers are situated on an orthogonal or parallel grid that is to be expected. These phenomena are referred to as center noise.

FIG. 30 shows a noisy center image for a square symbol matrix on a flat object surface area, wherein the extracted symbol centers are shown in black. Extracted centers are also situated on the object surface next to the symbol matrix. At some positions in the center image, no centers have been extracted, even though they should have been situated there in accordance with the corresponding symbol matrix. Even within the symbol matrix, soiling in the captured image or inaccuracies in the application of the graphical symbols by a laser mean that centers have been extracted at positions at which there are none to be expected. The matrix-like grid structure of the centers, is sometimes also not reproduced exactly in the center image on account of quantization errors, changing local recognition quality and perspective distortion.

FIG. 31 shows a flowchart for the column-by-column and row-by-row exploration of all symbols for creating the logical word matrix in accordance with aspects of the present invention.

FIG. 32 shows a schematic illustration of the inventive exploration of the extracted symbol centers by means of the method of “Region Growing”. In depiction a, the symbol center having the highest confidence value has been selected. From this starting point, a row of centers has been processed from left to right and from right to left, as symbolized by the arrows. In depiction b, a jump is made to the next lowest row. This and all further rows below it are marked according to the same scheme as shown as the outcome in depiction c. Depiction d shows the completely marked center image after the upper rows have also been explored from the starting point.

FIG. 33 shows explanatory illustrations of the method according to aspects of the invention for finding an extracted symbol center following estimation thereof. In this case, a symbol with a size of 6×6 pixels is shown. The center has been estimated. If there is no center on this pixel in the center image, a search is performed in surroundings at an interval of one pixel for the purpose of estimation, which takes account of a quantization error. The searched pixels are shown in depiction a. If no center is found here either, surroundings having the size of a symbol template are searched, with quantization errors being taken into account in this case too, as shown in depiction b. Depictions a and b each show the boundary of the symbol for which the center is being sought.

FIG. 34 shows illustrations of typical effects which occur when the edges of the symbols are not shown in clear-cut fashion, and the effect of said edges on the graphical symbols of the symbol code which are denoted by a and b in the depiction. The symbol shown in depiction a shows an overlay for the main feature, which is unmachined by the application technique. The symbol shown in depiction b shows the erosion of the machined main feature into the adjoining angular unmachined surface area. These effects typically occur when the symbols are burned onto a metallic surface by means of a laser using a DPM method.

FIG. 35 shows examples of soiling and damage as a result of scratches on the object surface. Black surface areas on a white unmachined object background represent soiling. White regions on machined object surface areas represent scratches, which cause brightly appearing reflections on reflective surfaces. Such imperfections can also be caused by imprecise application techniques. They may firstly occur locally at points or in the form of lines and may secondly be of a global type, so that a plurality of adjacent symbols are damaged.

FIG. 36 shows a rectangular symbol matrix with faults over a large surface area which extend to a plurality of adjacent symbols.

FIG. 37 shows a flowchart for the use of the dual template for finding parameters in accordance with aspects of the invention and a coarse illustration of the inventive extraction of the logical word matrix.

FIG. 38 shows a flowchart for a robust method according to aspects of the invention for exploring the centers, wherein local four-neighborhoods are linked to one another.

FIG. 39 shows a schematic illustration of the exploration of the extracted centers by the four-neighborhood method. Depiction a shows the centers of the graphical symbols in a rectangular symbol matrix. At some positions in the grid, centers expected at those points are missing. At other points, center noise means that centers are present which do not correspond to a graphical symbol. The four-neighborhoods of some centers have already been explored. Depiction b shows the process of exploration started in depiction a a few iterations later. Depiction c shows the intermediate result after all valid four-neighborhoods have been explored. Gaps produced stem from four-neighborhoods which cannot be explored completely, and are not filled until later in the process. Depiction d shows only the potential, partly incomplete four-neighborhoods for invalid centers. Since it is assumed that the poorer confidence for invalid centers means that these centers are not visited until after the state reached which is shown in depiction c, these neighborhoods can be rejected directly, since the centers which are adjacent to the invalid centers have already been referenced, namely in the state which is shown in depiction d.

FIG. 40 shows a coding and decoding algorithm in accordance with aspects of the invention which, for the purpose of decoding, uses the confidence values which this invention outputs for each word of the logical matrix in order to implement error correction.

### DETAILED DESCRIPTION OF THE PREFERRED EMBODIMENTS

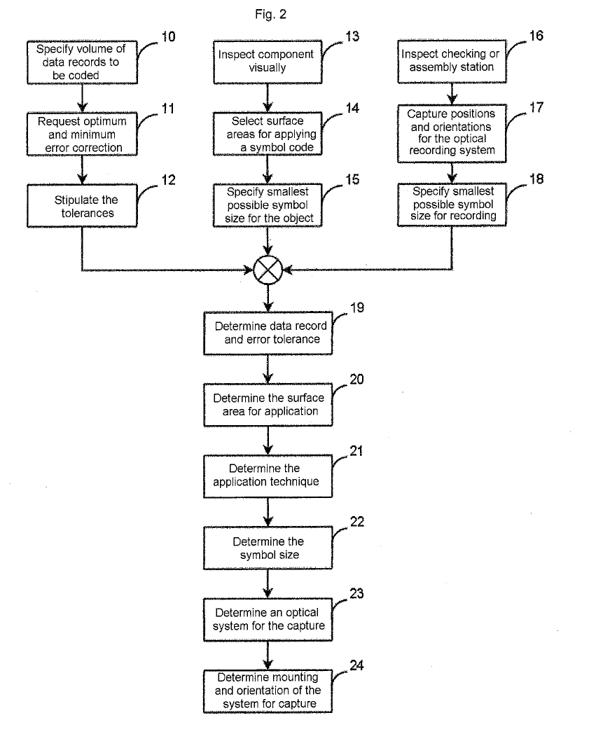

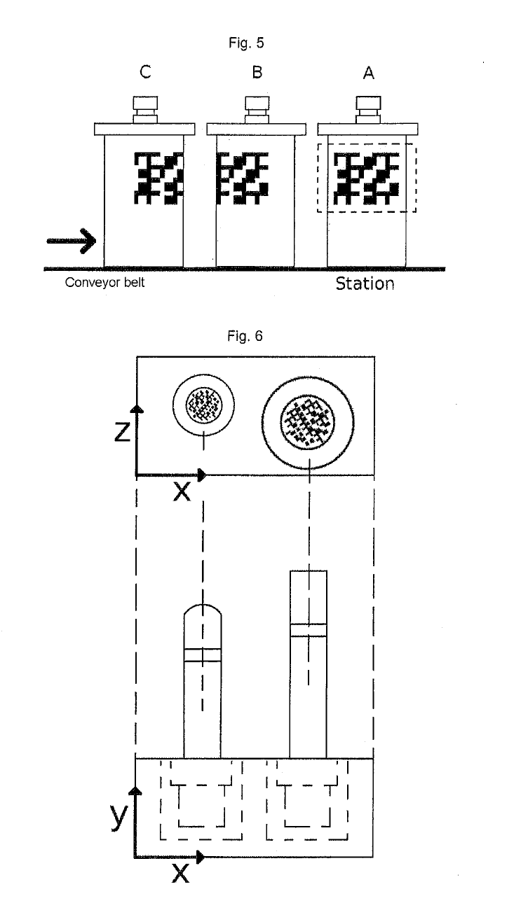

FIG. 1 shows the graphical symbols or symbol types for binary zero- and one-words. From these two symbols, any arbitrarily shapable symbol code is produced. FIGS. 2 to 4 and FIG. 7 show the process of decision-making for a symbol code and the incorporation into the production process as flowcharts. FIGS. 5 and 6 show specific examples of the application of a symbol code to a particular component, with the variability and versatility becoming clear in the application of the specified symbol code.

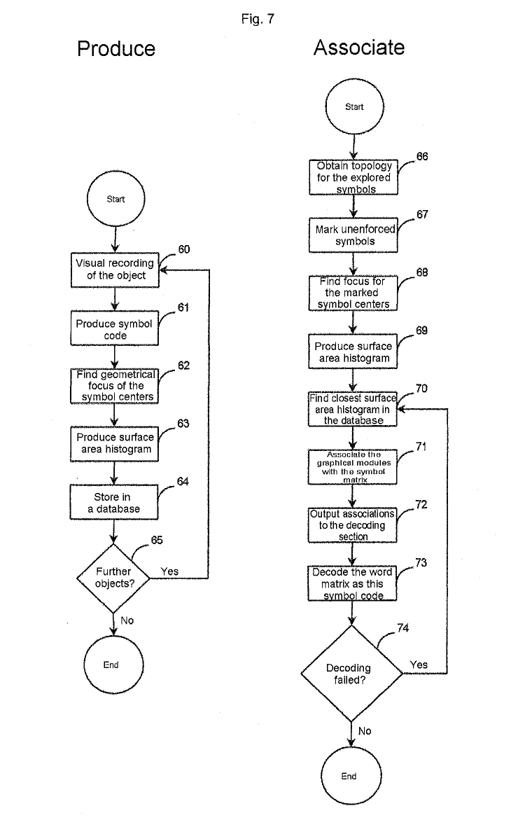

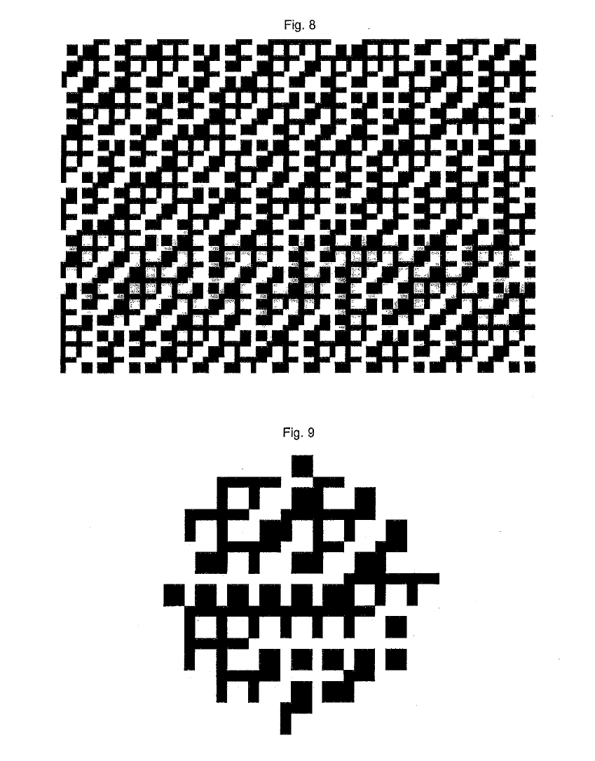

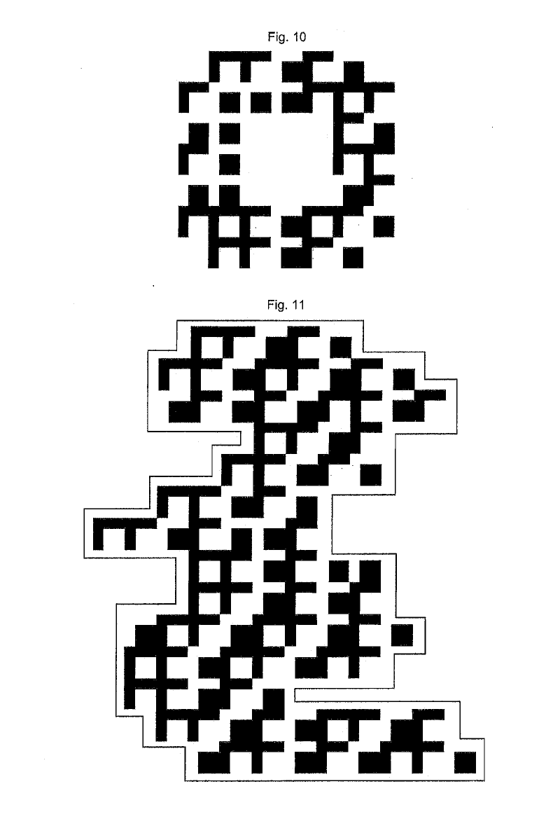

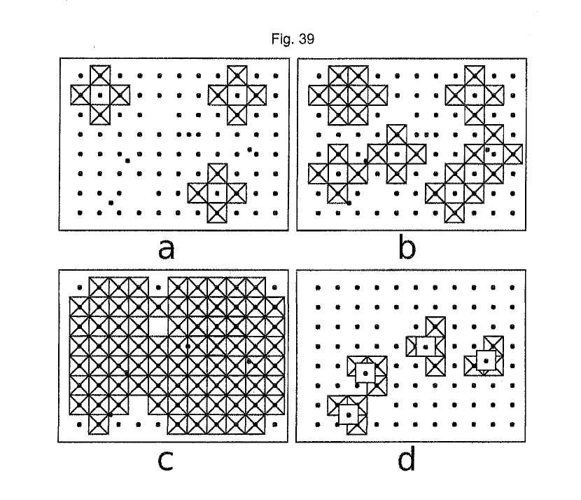

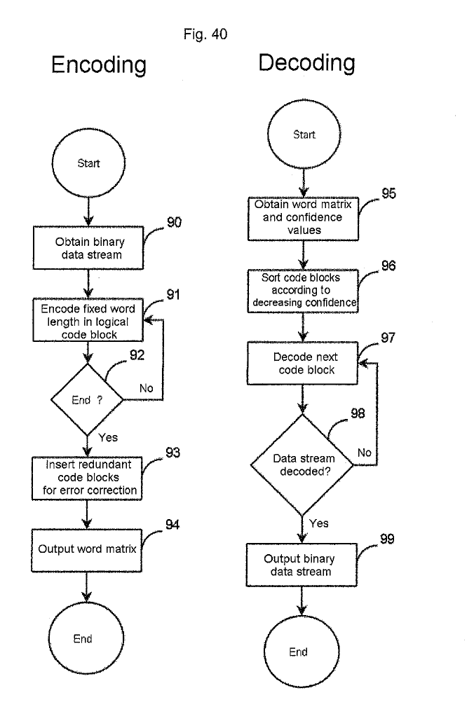

Differently shaped symbol codes, as shown by way of example in FIGS. 8 to 11 and 13, can be integrated into a production process without any problem, FIG. 15 and the flowchart from FIG. 7 describing the production and association of surface area histograms with the various symbol codes. An algorithm for decoding the binary words represented by symbols can only deal with symbol codes of a particular shape in each case, so that the surface area histogram of the recognized symbol code allows the associated algorithm for decoding to be addressed.

FIG. 16 shows the general flow of the method according to aspects of the invention. At the beginning, the positional or rotational parameters and the scaling parameters of the graphical symbols contained in an obtained (scanned-in) grayscale value image of the symbol code, which is also called a symbol matrix, need to be ascertained (method step 100). This is shown in detail in FIGS. 17 to 23, with several alternative methods being discussed. Next, a symbol template with the now known parameters is correlated to the image of the symbol code, i.e. the symbol matrix (method step 101 as shown in FIG. 16). FIGS. 25 to 27 schematically show the results of such correlation by way of example, with the type of the presentation not corresponding to the evaluated images, but rather having been produced for the purpose of suitable presentation in paper form. With the correlation result, it is subsequently possible to extract centers for the symbols contained in the symbol matrix (method step 102 shown in FIG. 16), which is done by means of a local maximum search for correlation values using a dilatation method. This is explained in FIGS. 28 to 30. These two processes are shown in summary in the flowchart shown in FIG. 24. The centers obtained are then traversed or explored (method step 103 shown in FIG. 16), with the word matrix being produced at the same time (method step 104 shown in FIG. 16). In this case, the word matrix corresponds topologically to the arrangement of the graphical symbols in the symbol matrix. However, a word matrix now contains only the logical words which have been encoded by corresponding symbols, and also, as supplementary information, a confidence value which describes the certainty of recognition of the respective ascertained symbol.

The exploration (method steps 127 to 144) is also shown in the flowchart shown in FIG. 24, which takes as a basis a region growing method, which is explained in more detail by FIG. 32 and FIG. 33 and also in the flowchart shown in FIG. 31.

FIGS. 34 to 36 show damage to symbols, which can result in little evidence of a symbol at a position. These difficulties need to be taken into account by a method for exploring extracted centers.

An alternative method for exploration to the “region growing” method is the region merging method, shown in FIG. 39 with the flowchart shown in FIG. 38.

FIG. 37 finally shows the general flow from FIG. 16 once again in more detailed form.

FIG. 40 describes how, in a final method step according to aspects of the invention, the confidence values which are assigned to a symbol by this method can be used beneficially for the implementation of a decoding algorithm for transforming a word matrix into a data stream.

If the aim is to introduce a machine-readable binary data record as symbol code—formed from the symbols shown in FIG. 1—for an object, the procedure shown in FIG. 2 is used to combine partly contrary demands in the best possible manner. In this case, there are limitations and demands on the desired volume of binary data to be stored (method step 10), the demanded reliability for the decoding (method step 12) and the resultant minimum or optimum volume of redundant binary data for the error correction (method step 11). In addition, limitations on the object itself (method step 13) need to be taken into account. By way of example, the object may have only a limited size and number of cohesive surface areas (method step 14) of which the desired or required object properties prevail, such as low reflection, adequate material strength, expected low probability of soiling or damage, and on which graphical symbols of a smallest possible size can be applied using possible application techniques in order to keep the symbol code compact (method step 15). By way of example, the selection of such surface areas for application may be limited by curvatures or nature and material strength of the object surface. Limitations in the assembly or checking station itself (method step 16) also need to be considered, allowing an optical system to be fitted and oriented only at a limited number of mounting points (method step 17). Besides the appliance for image capture, it may also be necessary for further illumination systems or additional units to be oriented in a particular configuration. In addition, that portion of the object that is to be captured must be visible, said portion achieving, in the captured image, a resolution in pixels which is determined by the optical system and which prescribes a minimum size for the graphical symbols of the symbol code (method step 18) so that these can be processed by image processing.

In practice, the originally formulated demands from method steps 10 to 12 are possibly not achieved to some extent, since the resultant limitations for method steps 13 to 15 and 16 and 18 are too extensive and the resulting solution which is defined in method steps 19 to 24 is not optimum. A symbol code which can also be applied in a manner split over object surface areas with complicated properties such as reflection or over a plurality of cohesive surface areas and is safely decoded with inhomogeneous illumination and a change in application quality extends the spectrum of application for symbol codes and optimizes the overall solution which can be achieved (method steps 19 to 24).

The graphical symbol shape specially optimized in accordance with aspects of the invention for an application technique of laser burning and the use of a grayscale-value-normalized correlation for the symbol extraction in the captured image, a freely selectable shape for the surface area for application and the dispensing with particular symbols or static patterns for position recognition and synchronization allow the effects of resultant limitations from method steps 13 to 18 to be limited in order to meet the demands defined in advance in method steps 10 to 12.

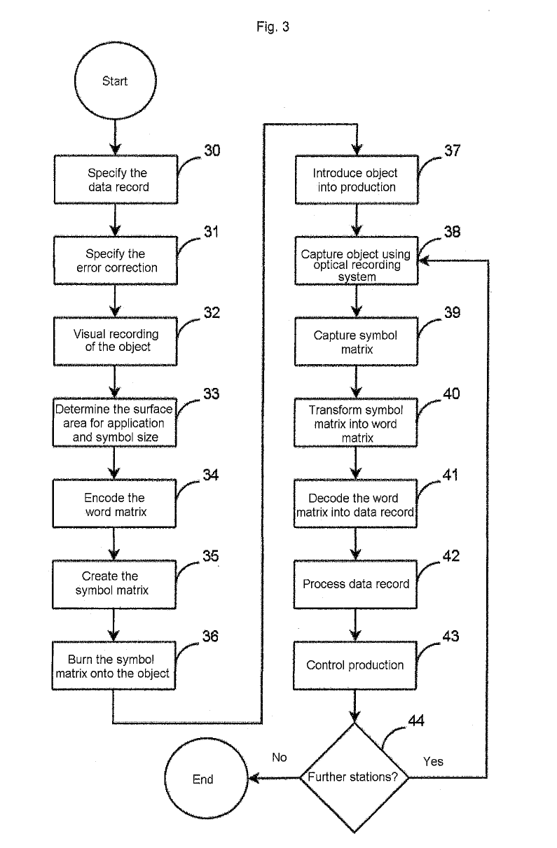

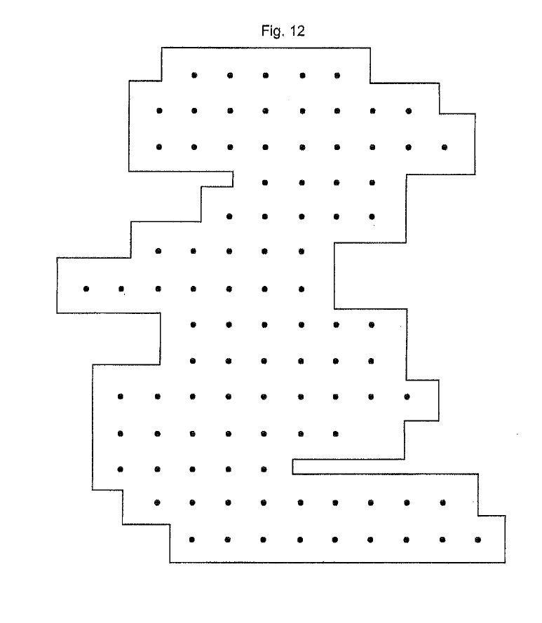

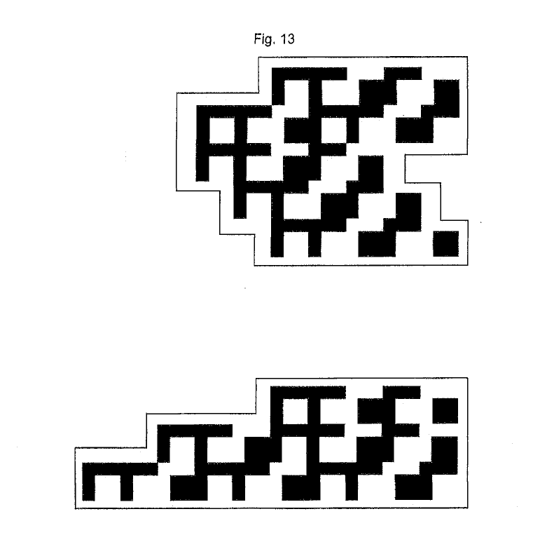

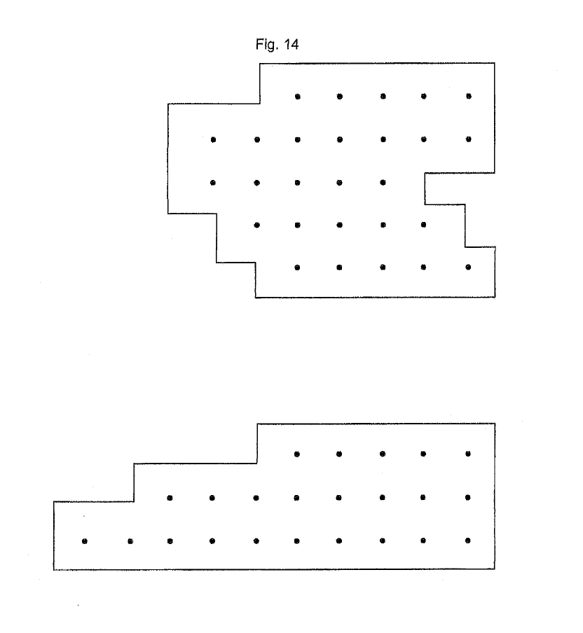

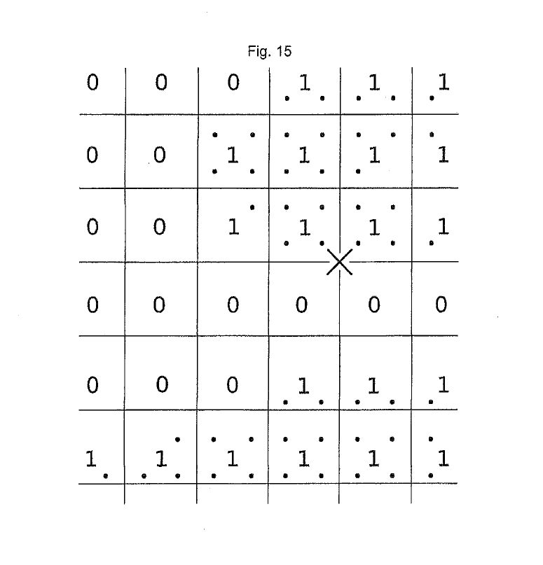

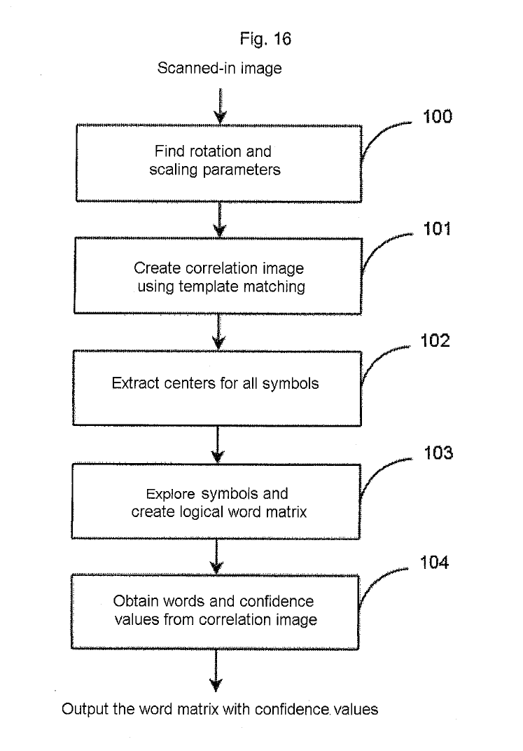

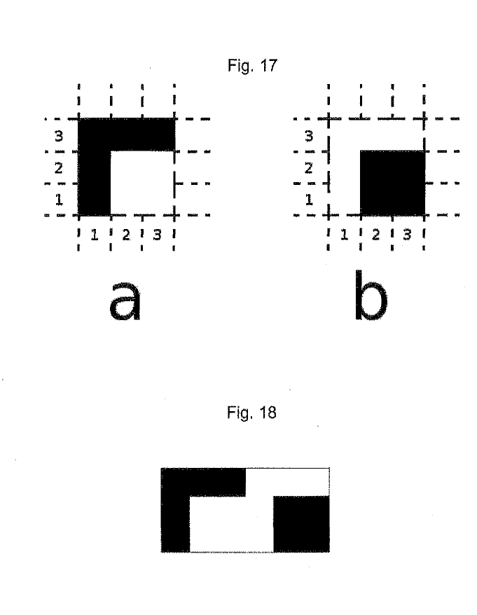

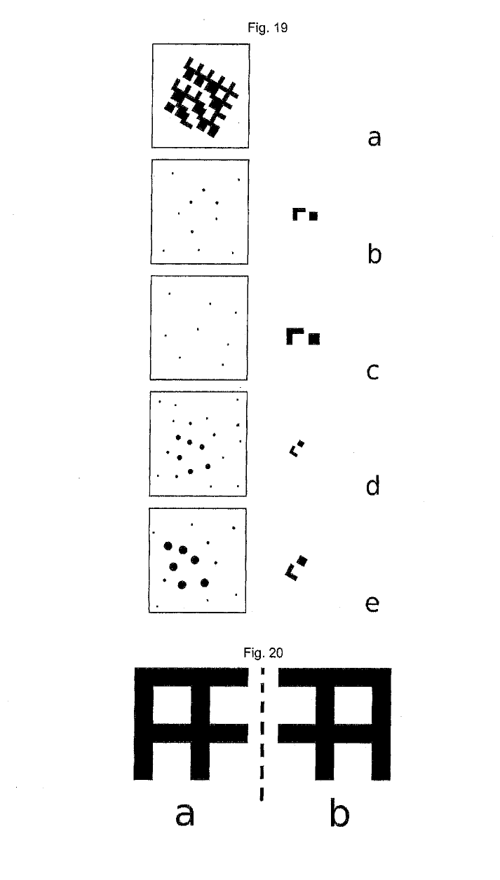

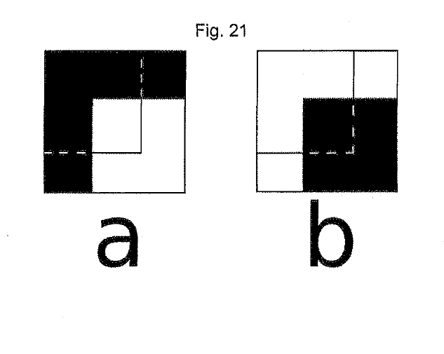

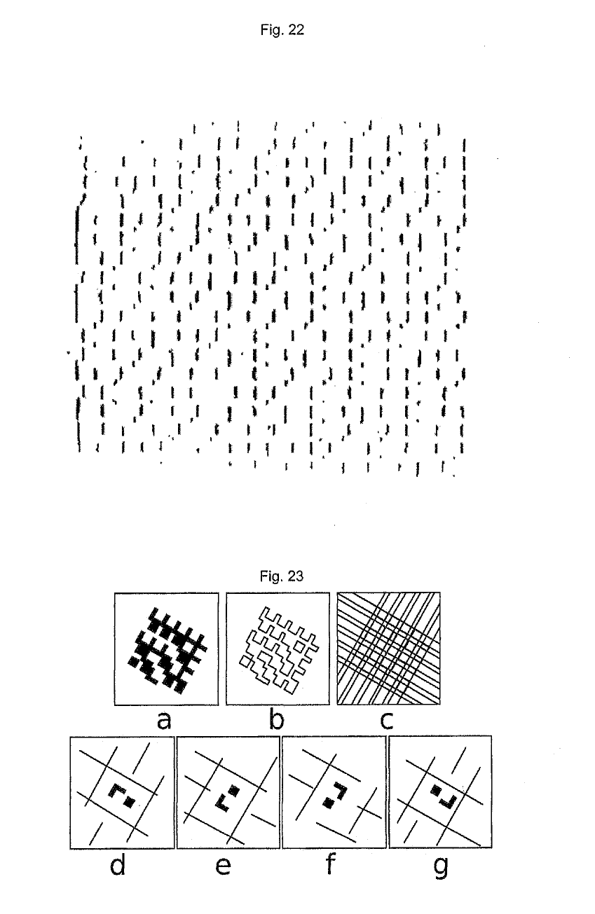

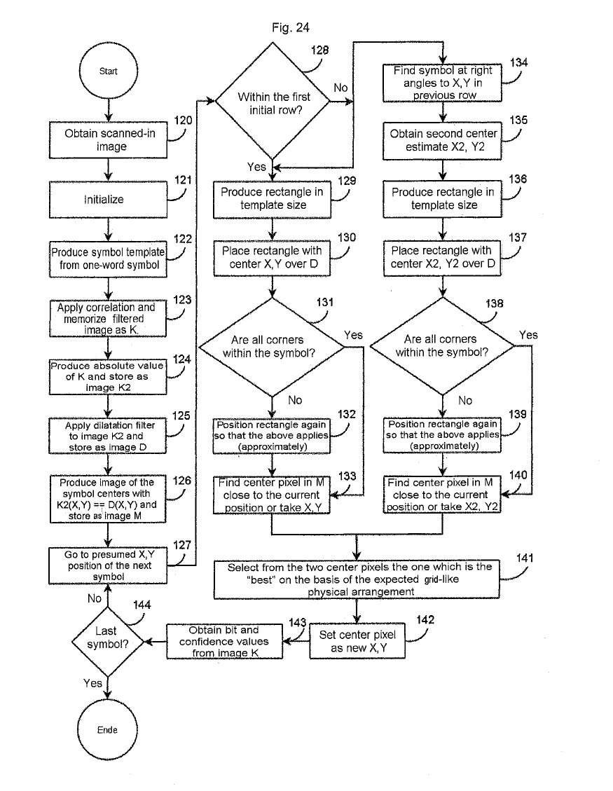

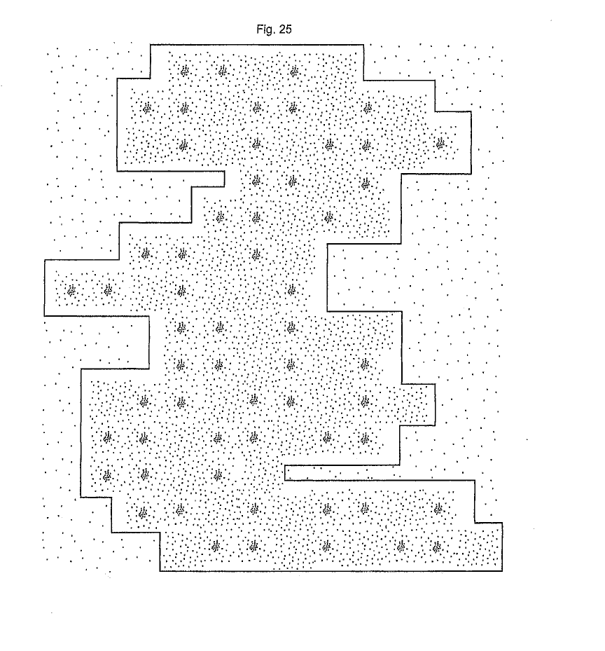

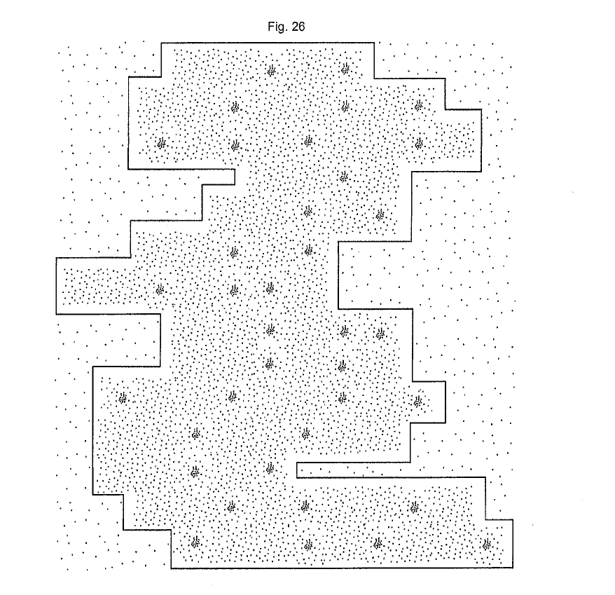

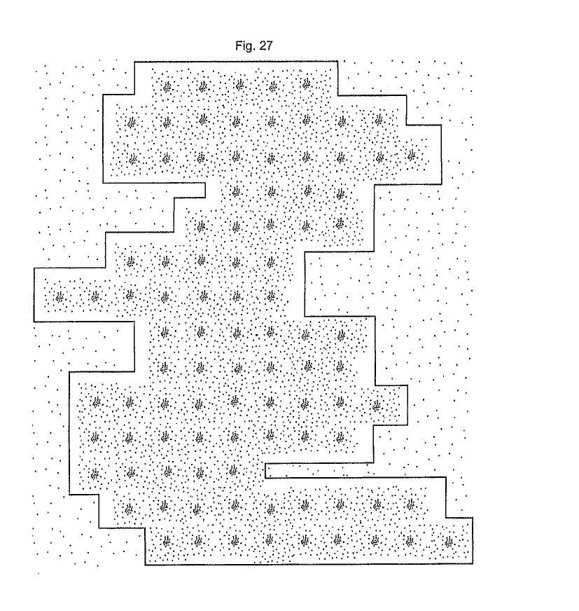

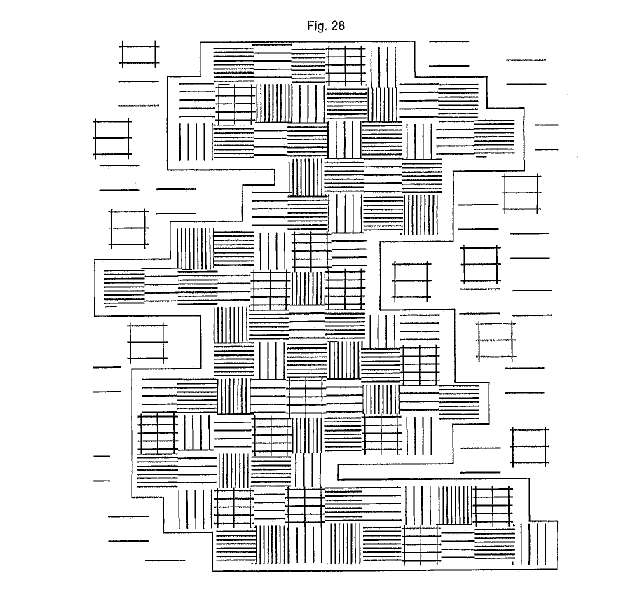

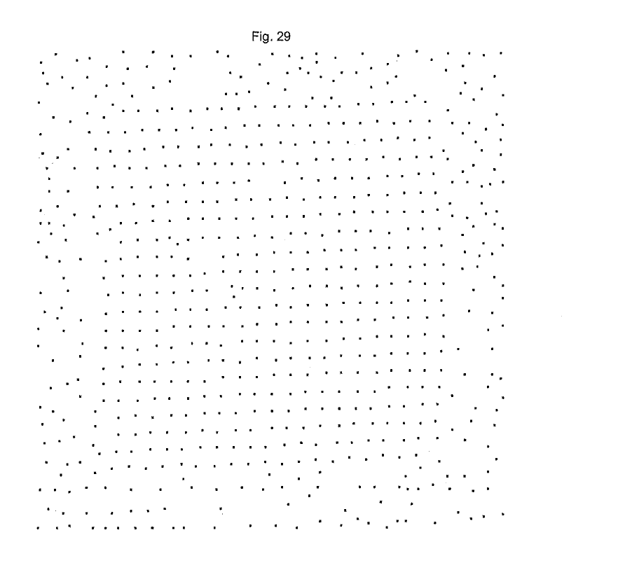

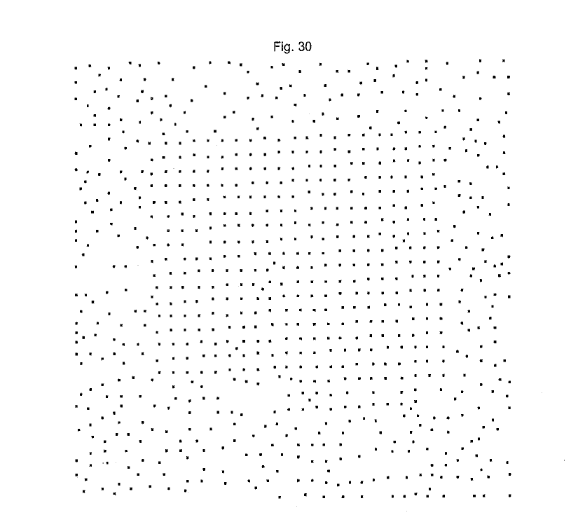

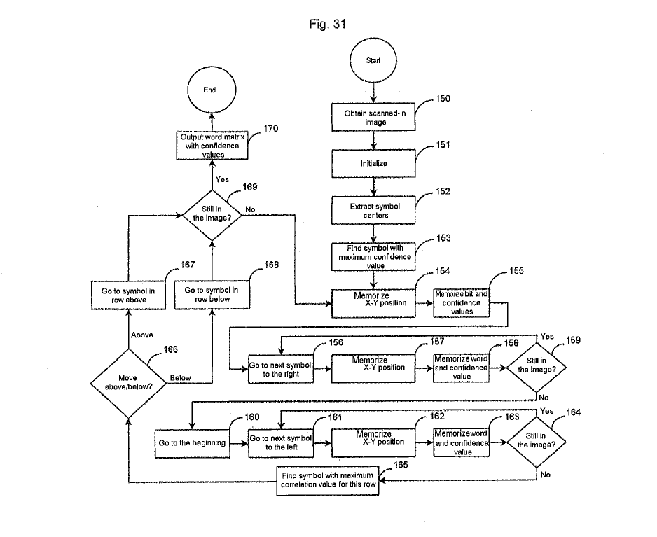

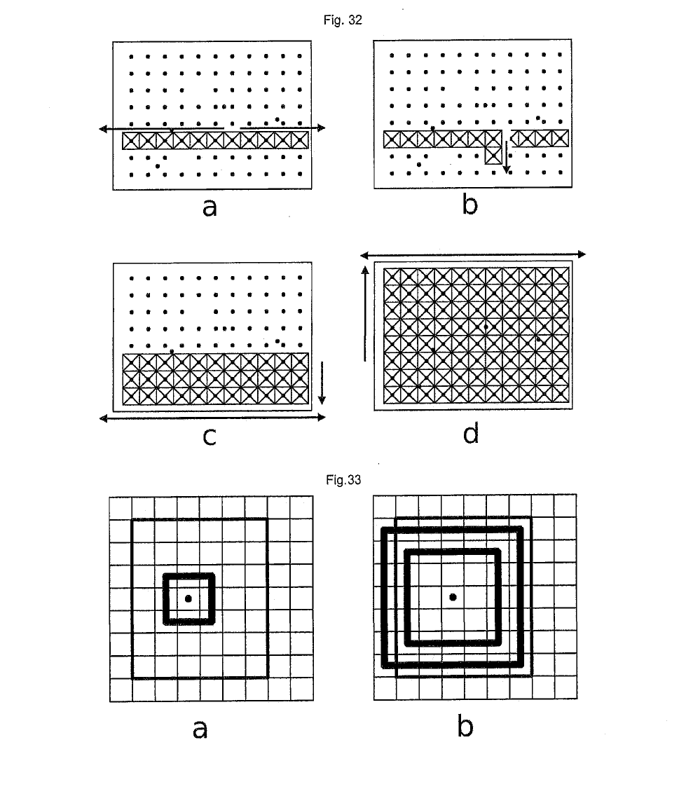

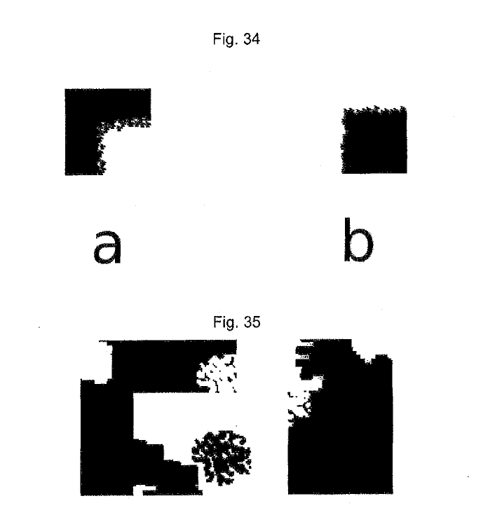

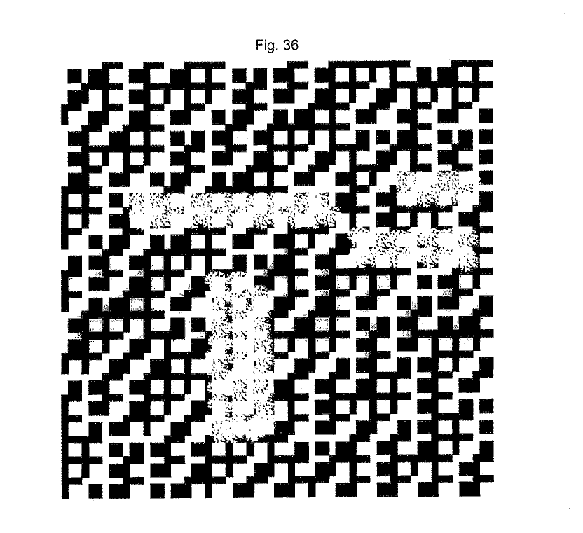

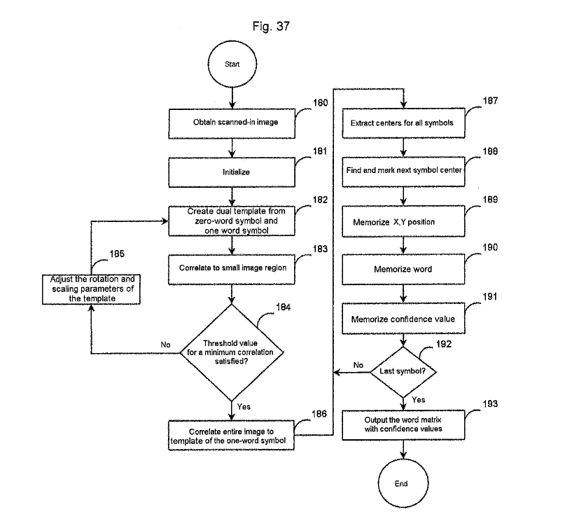

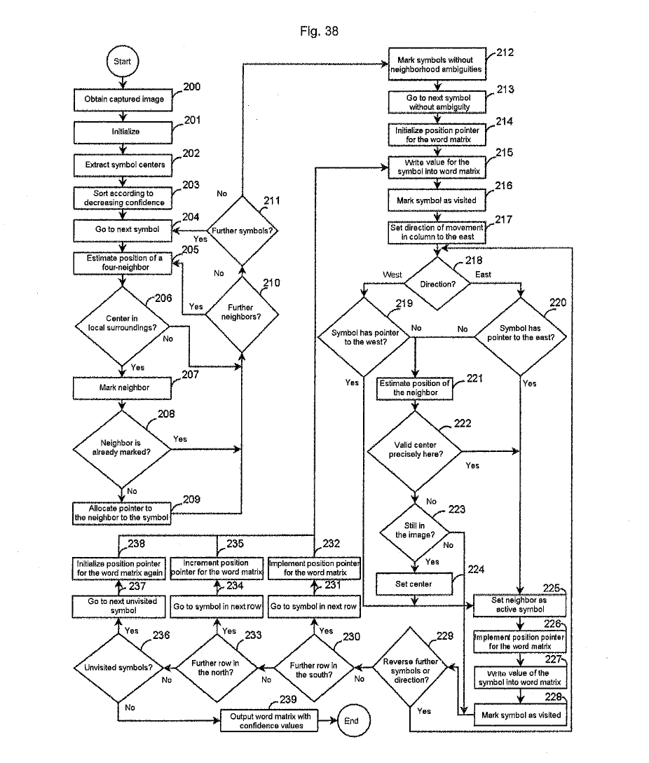

If, in accordance with the flowchart shown in FIG. 3, these preparatory prior considerations are taken as a basis for making a decision on the symbol parameters for a data record (method step 30) which is intended to be applied to the object in machine-readable form in a symbol code, and if the required redundancy for error correction is specified (method step 31), then the best possible surface area for application can be determined (method step 33) on the basis of the visual recording of the object (method step 32). It is now possible to parameterize a method for encoding using the contour which results from the shape of the surface area for application and using the density of the symbol matrix which is derived from the size of the graphical symbols. This outputs a word matrix, the number of columns of which corresponds to the maximum number of graphical symbols which can be accommodated in the vertical direction of the outer shape on the surface area for application, and the number of rows of which corresponds to the maximum number of graphical symbols which can be accommodated at right angles thereto in the horizontal direction of the outer shape on the surface area for application. The centers of the symbols of the symbol codes shown in the exemplary embodiments in FIGS. 11 and 13 are reproduced in FIGS. 12 and 14.

The word matrix produced contains a value zero or one in each cell, said values resulting from the process for encoding the selected data record with additional redundant error correction (method step 34) or having been prescribed otherwise, or contains no value at all if said cell is not part of the surface area for application. From the distribution of the words in the logical word matrix, the corresponding graphical symbol matrix is then produced by producing an image, for example a bitmap image, the dimensions of which correspond to those of a graphical symbol in pixels multiplied by the number of rows or columns of the word matrix, the arrangement being free and the number of columns per row (or vice versa) being able to vary. This makes it possible to produce images of the symbol matrixes which are optimally matched to the surface area for application.

For each word in the word matrix, a center for a corresponding topological position in the image is also calculated, so that none of the graphical symbols overlies another. In that case, the graphical symbol for a one- or zero-word is drawn in each of the resultant graphical symbol or data cells in the pixel image in accordance with the word value that corresponds to the data cell from the logical word matrix, as shown in Figures la and b. The thus produced image of the symbol matrix, as shown by way of example in FIG. 8, 9, 10, 11 or 13, is then sent to an appliance for applying the pattern to the object in method step 35 (cf. FIG. 3). By way of example, this is a laser which burns the symbol code at a prescribed position on the object (method step 36).

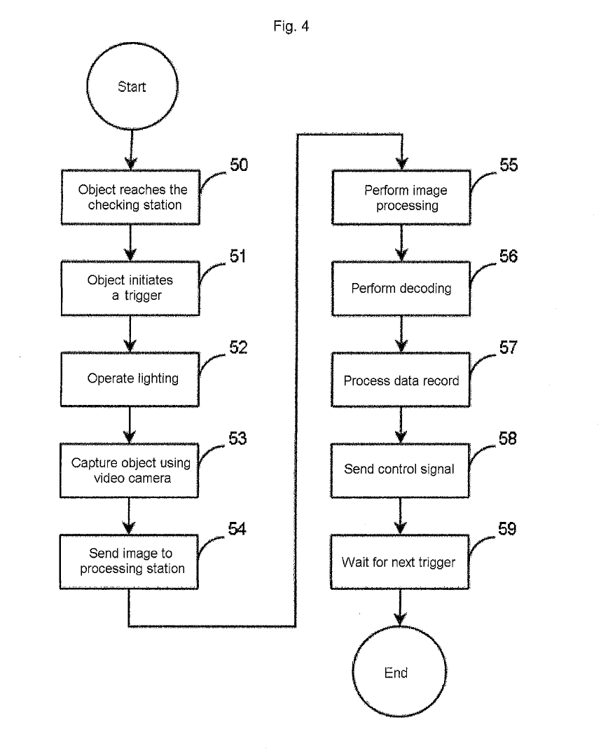

The marked object is then introduced into or returned to a production process (method step 37), where the object is captured in accordance with the further production steps at checking or assembly stations provided for the purpose (method step 38) in order to decode at that location the symbol code applied to the objects. The capture by an optical system at the checking or assembly station, for example a scanner or a video camera, takes place as soon as the object has reached the station (method step 50), as shown in detail in FIG. 4.

Thus, when the assembly station is reached by the object, a trigger is started (method step 51). This is possibly followed, and initiated by the trigger, prior to the recording of the object, by illumination devices being actuated (method steps 52) which produce a homogenous distribution of light during recording, if required.

The capture of the object by the recording device (method step 53) and the processing of the image material can take place in different appliances, so that the captured image is forwarded to an image processing appliance (method step 54). First of all, image processing installed in the appliance (method step 55) is used to extract the symbol matrix and to determine the centers of the symbol cells in the captured pixel image, as results from method step 39 in FIG. 3. After that, the symbol matrix is transformed into the word matrix corresponding to the symbol centers (method step 40), as will be explained in more detail later.

From the logical word matrix, the decoding algorithm (method step 56, FIG. 4) reconstructs the encoded binary data record (method step 41, FIG. 3), possibly using an available error correction information item. The binary data record can then be processed by a process computer in the checking or assembly station, as illustrated in method steps 42 from FIGS. 3 and 57 from FIG. 4.

These method steps have the same content and correspond, even though they are presented in different method cycles and are provided with different reference symbols. The reason is that the different method cycles put the same operations to some extent into a different logical overall context, so that there are recurrently overlaps between the various flowcharts.

The process computer sends control signals (method step 58, FIG. 4) to remote appliances, possibly on the basis of the processing result. The capture station then awaits a new object (59). The transmitted control signals can control the rest of the production process, for example (method step 43, FIG. 3).

During the production process, the same object can be captured on different further stations and in the same way the symbol code can be evaluated, as is intended to be indicated by method step 44.

Since, on the basis of the application technique, the capture technique and the surface material, the logically black and white surface areas of the graphical symbols presented in FIG. 17 in depictions a and b may have actual grayscale values in a brightness which is the opposite of the logical definition in the pixel image captured for the purpose of image evaluation—which pixel image is not in color in this example, this must be taken into account as a parameter of the overall system and possibly parameterized beforehand.

The text below describes the process of image processing following the capture of the object by a video camera, for example, in more detail.

Whereas the angular surface area of the graphical symbol shown in FIG. 1 and FIG. 17, in each case depiction a, is bilaterally narrow and elongate in shape, the square surface area (depiction b) is, by contrast, wide and filling. This latter shape is therefore subsequently also referred to as a main feature.

If other symbols are arranged around a symbol with unmachined main feature in such a way that said main feature is entirely surrounded by machined regions, the relative size of the main feature means that the effect of an overlay is diminished because the square is twice as wide and high as the width of the lines associated with the angular surface area, which lines would bound said square surface area. If the main feature is machined and the adjoining angular surface area remains unmachined, the problem of erosion or overlay for the angle range is increased in comprising with the previous example, since the unmachined surface area is narrow.

In this case, the main feature can be applied, in accordance with aspects of the invention, with a somewhat smaller surface area from the outset, for example, in order to compensate for the expected effect. However, this does not reduce a reliable distinction, since discrepancies caused by erosion in the grayscale values of the captured symbols in relation to the optimum templates thereof cancel one another out in a relative comparison if the symbols are recognized using the correlation method according to aspects of the invention, in which the Euclidian interval is a measure relating to the association. For this reason too, the symbol code according to aspects of the invention and the associated method for reading the symbol code are particularly robust and reliable.

Following this preliminary consideration, the general flow of image processing within the context of the reading method according to aspects of the invention is now explained on the basis of FIG. 16.

In order to extract the symbol matrix from a recorded or scanned-in image of the symbol matrix, the rotation and scaling parameters of the individual graphical symbols need to be captured (method step 100). Depending on the recording situation and embedding of the image capture into the production process, an object can be rotated differently and positioned at a different distance from the camera, so that the parameters are determined preferably dynamically, i.e. in the respective recording situation, in accordance with aspects of the invention.

On the other hand, situations exist in which objects to be captured have only a displacement but do not significantly change their interval relative to the capture system, which means that the scaling and rotation parameters can be firmly prescribed. It is possible that only rotations of the object can be expected, which means that in such an object only the rotation parameters need to be estimated.

Both are effected by trying out various probable combinations of parameters, on the basis of which a respective template as show in FIG. 17 (symbol template) and FIG. 18 (dual template) is produced and the correlation result following application of the various parameters is evaluated. When the correct parameters have been found, the entire captured image can be correlated to an adaptation of the graphical symbol in accordance with these parameters. This correlation is also called template matching (method step 101), because the match between a template and an image or a subregion of the image is examined. The correlation result is then evaluated and the pixel coordinates of the symbol centers in the image are extracted (method step 102) which represent the originally applied symbol matrix. The extracted symbol centers are then successively explored in the pixel image (method step 103), so that their logical proximity to all other symbol and data cells is retained.

Only from the traversed symbol centers is the word matrix then reconstructed (method step 103), wherein the word associated with a symbol center is derived from the degree of match with one of the two graphical symbols at this pixel position (method step 104). The degree of match for the correlation of the symbol template is ascertained as a confidence value for the correlation and indicates the quality and certainty of association of a word with this position. The ascertained words and the associated confidence values are output as a word matrix, with the word matrix in this case containing more negative and positive floating point values—which equivalently represent the two words and the confidence value at the same time—instead of zero and one values. This word matrix is either output directly to the method for decoding and restoring the binary data record or the surface area of the symbol code for application is determined before as a further parameter, said surface area being determined by its shape. The procedure for this is explained fundamentally in FIG. 7.

The method flow explained as an overview above with reference to FIG. 16 is presented again in more detail below.

The rotation and scaling parameters (method step 100) are ascertained by what is known as initial testing. This is portrayed in method steps 182 to 185 in FIG. 37.

The procedure is shown in FIG. 19. For the template matching, a dual template is used which is shown in FIG. 18 and comprises two adjacent graphical symbols. The dual template is produced dynamically in the bitmap memory using typical parameters (method step 182). By way of example, if a symbol size of eight pixels lateral length and a rotation of zero degrees are assumed, the template can, on the basis of the relative size ratios for the machined and unmachined surface areas, as can be seen from FIG. 17, be drawn in a bitmap memory which has a height of eight pixels and a width of 16 pixels for the exemplary dual template. When the symbols are drawn, only two respective different grayscale values are required, that is to say, by way of example, the value “255” for filling the white unmachined surface areas and the value “0” for black machined surface areas.

A dual template is used instead of just a single symbol, for example, since in this way superordinate patterns are produced when individual symbols within the symbol matrix are arranged directly next to one another without any further interspace between the cells. Such superordinate patterns, for example within a four-neighborhood of symbols which is shown in FIG. 20, are very similar to the pattern for an individual symbol, but have rotation parameters which are different by a multiple of 90° in relation to the actual orientation of the symbol matrix. A good correlation for the superordinate patterns can be prevented using the dual template.

This dual template is then applied to the grayscale value image to be analyzed in a normalized correlation method (method step 183). Since the dynamic production described and the subsequent correlation are possibly performed a plurality of times using different parameters (method step 184), speed can be increased by also using only a comparatively small subregion instead of the entire image, or alternatively a plurality of details from different positions of the image, for the purpose of correlation. These subregions are then usually chosen to be rectangular for the sake of simplicity, with the lateral lengths thereof forming a multiple of the height and width of the current dual template. Initial testing makes sense only in representative image regions in which the correlated template can also be found. Since at this time in the image analysis it is not known—unless additional information is available—at what position in the image the symbol code is located, however, it can be assumed that it extends primarily over the central image region. If the orientation of the capture appliance means that other image regions are more relevant, it is possible to define other or a plurality of such subregions.

When the correlation has been applied to all of these image regions or possibly the entire image, confidence values are available for each pixel as a correlation result. These confidence values are assessed in method step 184. The maximum confidence value—in terms of absolute value—for all correlated image regions is established and a check is performed to determine whether this exceeds a stipulated minimum value. If such a minimum confidence value is reached, it can be assumed that rotation and scaling parameters have been found which are close enough to be actual values, and the rest of the search can be terminated. This state has been reached in FIG. 19e, but not in the case of the correlations with differently scaled or rotated dual models that are shown in FIG. 19b to FIG. 19d.

Since a statically chosen minimum value ignores further parameters of the capture system such as light conditions, cleanliness of the object, inherent structure of the object surface and the like, which constantly diminish the maximum confidence values achieved, a fixed minimum threshold value can prevent the successful extraction of the rotation and scaling parameters. A threshold value can therefore also be chosen adaptively in accordance with aspects of the invention by producing (method step 182) and correlating (method step 183) a dual template for a constant number of rotations and scalings (method step 185) as shown in FIG. 18. Next, a maximum confidence value for all correlation results is sought (method step 184). The appropriate parameters are then regarded as very close to the actual parameter and are used subsequently.

Alternatively, when coarse determination of the parameters has taken place in this manner, further improvement of the parameter estimation can be achieved in the same way if variation is effected in local surroundings of the parameter space close to the performed estimation in order to obtain more precise values for the approximated parameters.

Prescribed parameters need to be chosen such that the actual parameters can be estimated sufficiently well from the correlation results of the dual template in order to obtain beneficial confidence values during the later correlation with just one symbol template for the purpose of reading the symbol matrix which is produced with the parameters found in this case. In particular, the chosen parameterization specifications should allow the threshold value set in method step 184 to be exceeded. They should thus firstly not be too distant from all actually possible combinations of parameters, but should secondly also not be too extensive in number to save computation time.

In accordance with one refinement which has been tried out in practical studies, it is possible to try rotation parameters at intervals of 30°, for example, that is to say 0°, 30°, 60°, 90°, 120°, 150°, 180°, 210°, 240°, 270°, 300°, 330°, so that this already means up to twelve implementations of the positions in method steps 182 to 185 for a fixed scaling parameter. The scaling parameter can additionally be varied, however. In this case, typical lateral lengths of 6, 8, 10, 12, 14, 16 pixels for a symbol can be assumed. Overall, all combinations of the parameters are then captured in 12*6=72 passes. This can be performed with modern computers so quickly that no delays in the method flow need be feared.

The number of attempts can be reduced by taking into account the arrangement of the black and white surface areas, which remains approximately constant at the center of a symbol. Thus, a symbol template with smaller scaling than the one which is actually present in the grayscale value image can provide adequate confidence values for additionally approximated rotation on the basis of a correlation. Scaling factors can thus also be underapproximated (FIG. 21), which is why scaling of 6, 10, 14 pixels lateral length are sufficient to arrive at sufficiently accurate estimates particularly of the rotation parameters, which can then be further refined in their local surroundings. In order to reduce the computation complexity, an adaptive method of this kind is appropriate.

If additional knowledge is available, it is also possible, by way of example, to use landmarks in the components or in the surroundings captured in the image in order to initialize the rotation parameters (method steps 182 and 185). By way of example, another type of knowledge could also mean that it is known whether subsequent components will have similar rotation and scaling parameters, as a result of which the most recently found parameters can be used as initialization (method step 182) for subsequent capture.

A further option for reducing the number of rotation parameters to be initially tested is possible by virtue of image preprocessing by means of Hough transformation or Radon transformation, which needs to be performed before method step 182. The symbol matrix primarily comprises interrupted straight, parallel and orthogonal line segments, as are shown in FIGS. 22 and 23. In addition, a Sobel filter mask can be used, which is an edge detection filter which is frequently applied in image processing and is used as a Sobel algorithm in that case with the aid of the convolution. This filter calculates the first derivation of the pixel brightness values, with smoothing simultaneously taking place orthogonally with respect to the derivation direction.

If the Sobel filter mask is applied with subsequent Hough transformation for the purpose of recognizing straight lines to the image regions stipulated as described above, the gradient of the main direction of all grayscale value edges within a region can be captured in each case. This is illustrated in FIG. 23. For the purpose of recognizing geometric objects, the Hough transformation produces a dual space into which, for each dot in the image which is situated on an edge, all possible parameters for the figure which is to be found are entered in the dual space. Each dot in the dual space therefore corresponds to a geometric object in the image space. In the case of a straight line, this may be the gradient and the y-axis section, for example. Accordingly, the dual space is evaluated for accumulations in its dot entries, which then correspond to the figure being sought.

If a plurality of image regions are captured separately from one another, resulting gradient values can run either parallel or at right angles to one another if an XY Sobel filter is used.

The thus obtained gradient information can now be used for initialization in method step 182 and method step 185. Rotations now need to be initially tested only in 90° steps relative to the gradient found, as can be seen from FIG. 20. If the image data to be evaluated are not too noisy, the interval between parallel lines in the Hough transformation can also be used for initializing the scaling parameters. When the rotation and scaling parameters of the symbols have been extracted, the relevant symbol template can be produced and the entire image region of the symbol code can be correlated.

First of all, a symbol is drawn in the bitmap memory on the basis of the rotation and scaling parameters obtained through initial testing (method step 101 shown in FIG. 16, method step 122 shown in FIG. 24 and method step 186 shown in FIG. 37). Alternatively, the original image can also be rotated, as a result of which the symbol template can be drawn with fixed rotation parameters and only the scaling thereof needs to be taken into consideration. For the automatic production, a symbol from the symbol code is logically split into a 3×3 array of square cells of equal size, with ⅓ of the surface area being drawn in black and ⅔ of the surface area being drawn in white (or with a converse spilt in the case of the one-word symbol) horizontally and vertically. This is illustrated in FIG. 17. This bitmap produced has a histogram with values 0 (black) and 255 (white). It is assumed that this corresponds to a noise-free original of the symbols to be found in the recorded image. In this case, the exact grayscale values of the symbol template are not important for the correlation, but rather only the fact that two homogenous surface areas of respective different brightness in the contour and distribution determined by the symbol exist in the image detail which is to be correlated. It is therefore completely irrelevant whether a zero-word symbol template or a one-word symbol template is now used for correlation. Subsequently, the arithmetic signs of the confidence values then need to be interchanged as appropriate, however, in order to obtain the same word matrix.

The template from the bitmap memory is then correlated to the overall image that is to be evaluated or to a previously stipulated image detail in a normalized correlation method (method step 101 shown in FIG. 16 or method step 123 shown in FIG. 24). The result of the correlation is a new image, produced in method step 123, with the same dimensions as the original image to be correlated minus the width or height of a symbol. The pixels of the correlation image each contain the correlation result at the corresponding position of the original image, as shown for the two complementary symbol templates in FIGS. 25 and 26. In the case of the correlation, the grayscale value distribution of the symbol template has its center placed over each pixel of the image to be evaluated. For this pixel, a value between 1.0 and −1.0 is determined, which is a measure of whether this pixel is a center for the symbol template.

In addition, the grayscale values of the image to be evaluated, above which grayscale values the symbol template is situated, are first of all normalized, so that ideally only two values are required for presenting the brightness distribution (as when the template is produced). In that case, the Euclidian interval between a pixel of the template and the corresponding and normalized pixel for said template, situated directly beneath it, in the image to be evaluated is then calculated. The sum of all Euclidian intervals for grayscale values in the catchment region of the symbol template than forms the value of the pixel in the correlation image, which has been scaled to a range from 1.0 to −1.0. A value of −1.0 for a pixel means that this point in the original image is not at all the center of a symbol which is being sought. Since it has precisely the brightness characteristic which is complementary with respect to the symbol template, however, it must therefore then be the center of a one-word symbol when a zero-word symbol has been used for correlation. If a pixel in the correlation image has the value 1.0, it is quite certainly the center of a zero-word symbol. Values between 1.0 and 0.0 and between −1.0 and 0.0 can be interpreted as the degree of similarity between an image detail and one of the two symbol types.

These values are therefore called “confidence values”. By way of example, a value of 0.82 means that a pixel has an 82-percent probability of being the center of a zero-word symbol. A pixel having a value of −0.54 accordingly has a 54-percent probability of being associated with the center of a one-word symbol. The chosen shape of the symbol reveals that around the center of a symbol there are values very close to, ideally, values of 1.0 or −1.0, which means that all symbol centers can be located.

The correlation image produced by means of the previously explained template matching (method step 123 shown in FIG. 24) contains a grayscale value distribution with values from 1.0 to −1.0, which are shown separately for the two ranges 1.0 to 0.0 and −1.0 to 0.0 in FIGS. 25 and 26. The pixel coordinates of the centers of all symbols in the symbol matrix are not intended to be extracted therefrom (method step 102 shown in FIG. 16, method step 152 shown in FIG. 31 and method step 187 shown in FIG. 37). This means that maxima need to be found within local regions, which correspond to the bounding of a symbol template.

To this end, a new image memory is first of all produced which contains the absolute values of the pixels of the correlation image, so that the value range lies between 1.0 and 0.0 (method step 124). Such an image is shown in FIG. 27 and ideally shows a maximum corresponding to the center of the symbol in each data cell of the symbol code.

In accordance with aspects of this invention, an adaptive approach to extracting local maxima is tracked which eliminates the problems of global threshold value formation. To this end, a dilatation filter is applied (method step 125) to the absolute value image of the correlation values which is reproduced in FIG. 27 (method step 124). As a good example, the effect of the dilatation filter is that at each pixel of a first object the complete image of the second object is inserted.

In the specific example, the morphological operator operates on a grayscale value image. The dilatation filter has, as a structural element, a rectangle of the same dimension and the same external contour as the symbol template used for the correlation, since it is assumed that these are precisely the dimensions of the symbols which are actually situated in the captured original image. If this dilatation filter is applied to a grayscale value image such as the absolute value image of the correlation values shown in FIG. 27, maximum formation takes place between the buffer-stored grayscale value of the dilatation filter and the respective grayscale values of the underlying pixels of the original image which correspond to the structural element. The maximum grayscale value of two such pixels is then written into the original image at the same location. The buffer-stored grayscale value of the structural element is defined as that grayscale value of the pixel in the original image which is currently below the center of the dilatation filter, the center of which is placed over each pixel of the original image.

Thus, a copy of the absolute value image is produced which is called a dilatation image (method step 125). Next, the dilatation filter has its center placed over each pixel of this copy of the absolute value image, and the maximum formation of pixel values is performed within the catchment region thereof. Thus, the result obtained is a grayscale value image whose grayscale value is shown as lines of different density in FIG. 28. In each region at which a symbol is located in the scanned-in original image (method step 120), a homogenous filled rectangle is now shown with the grayscale value which corresponds to the confidence value of the estimated symbol center, which is at a maximum in its local surroundings determined by the dimensions of the symbol template and has been extracted adaptively by virtue of the maximum formation in the dilatation filter (method step 125).

The estimated symbol centers can now be located by marking those pixels which have the same grayscale value in the absolute value image and in the dilatation image (method step 126). Pixels having this property can be regarded as local maxima which can be associated with actual symbol centers with a very high level of probability. These can be copied into a center image, as shown by way of example in FIG. 29 or 30, having the same dimensions as the captured original image, with centers being assigned the value zero (black) and all other pixels being assigned the value 255 (white), for example (method step 126).

In practice, however, not every pixel extracted in this manner is necessarily an actual symbol center. If a graphical symbol from a symbol has been damaged to such an extent that its actual center has a low confidence value in the absolute value image, it is possible for confidence values within adjacent symbol cells at positions which are not the actual center thereof but rather are at a greater distance therefrom to have a higher confidence value locally than the symbol center which is actually to be associated with this cell. The surroundings of the symbol matrix, which represents object surface and is no longer part of the actual symbol code, have local maxima at many locations, said local maxima being entered in the center image. These maxima are caused by structures on the object surface which are not part of the symbol matrix, and said maxima do not follow an interpretable pattern.

The inventive method described above has the advantage of using no threshold values as parameterization. It adapts itself locally in a region to the confidence values provided for each pixel of the absolute value image. In this way, relatively low recognition certainties caused by local reflection, soiling, application errors are taken into account. A threshold value would, in the case of these inequalities, fail and extract no centers if it is chosen to be too high. The method does not need to be initialized by a constant parameter, which would need to be ascertained by a human expert with a high level of calibration complexity.

It is now necessary to explore the extracted symbol centers and to write words from the graphical arrangement of the symbol matrix into the corresponding word matrix. When the probable centers have been extracted (method step 102 shown in FIG. 16), they can be explored (method step 103).

Exploration holds the difficulty that although the positions of centers are known from method step 102, firstly the coordinates obtained are noisy and secondly perspective distortion in the image means that the centers of rows and columns are not arranged or do not need to be arranged strictly at right angles to one another, i.e. the rows and columns are not oriented parallel to their respective coordinate axes in the image detail to be analyzed. The noise results from the method for extracting local maxima also having extracted, in method steps 125 and 126 (cf. FIG. 24), such maxima as centers as are caused by the structure of the object surface and therefore are not centers of graphical symbols. These false centers need to be ignored during exploration, which means that they are unable to be included in the word matrix later.

If surface area elements within the symbol matrix are damaged by soiling, scratches, reflections or the like to such an extent, as shown in FIG. 36, that the structure of the damage has a greater influence on the correlation filter than the destroyed graphical symbols, centers within the symbol code to be explored are also noisy for the reasons described above. Damage to individual symbols means that the extracted center thereof may be at a great distance from the actual symbol center. It is also thus possible for no centers to have been extracted on individual symbols or in areal regions and therefore for the evidence of a symbol to be entirely absent at this location in the center image.

It is therefore desirable for an algorithm for exploring the centers to be able to distinguish the various types of noise and either to correct a center or instead to ignore it and to fill gaps produced on account of absent centers. In addition, it should adjust itself adaptively to the changes in the local gradient of the symbol row or column which are caused by distortion, but at the same time should correct deviations from the expected pixel position which are caused in the opposite direction by center noise.

The text below describes two methods according to aspects of the invention with such capabilities, which differ in terms of their runtime behavior. The first method, described first, works on the basis of the “zigzag” principle and, on the basis of a starting point, estimates an adjacent center, the adjacent center of which is estimated again and then refined, etc. The method can therefore be put into the category of “Region Growing”, as explained schematically in FIG. 32. It is simple and fast when the center estimates are good and exhibit little noise. Particularly in the case of dense symbol codes with lateral lengths for the symbols of less than eight pixels, this method is usually inefficient on account of the computation-intensive treatment of outliers, however.

Alternatively, a second method according to aspects of the invention is described which first of all explores a four-neighborhood for each center. In this case too, expected center positions are estimated but are refined only locally. These neighborhoods are produced separately for each center. Next, adjacent four-neighborhoods are combined and in this way the entire symbol matrix is reconstructed. This method can therefore be put into the category of “Region Merging”, as explained schematically in FIG. 39. Outliers are dealt with by virtue of each center being able to be referenced only a single time and also each center associated with the symbol matrix needing to have a complete four-neighborhood. This eliminates outliers, for at least one of the demanded properties does not apply.

Both methods assume a grid-like structure for the center distribution, as a result of which a right and a left and a top and a bottom neighbor, respectively, exist for a symbol cell within the symbol matrix, as shown in FIGS. 12 and 14 for the data cells which are not situated at the edge. The imaginary connecting lines from the right to the left neighbor and from the top to the bottom neighbor are ideally assumed to be at right angles to one another, and they should intersect at the center of the current symbol cell.

When the probable symbol centers have been extracted into a center image in method step 152 as shown in FIG. 31, the symbol center with the maximum confidence value is taken as a starting point (method step 153), since it can be assumed that this safely represents an actual symbol center. In this case, the confidence value is read from the absolute value image K2 (method step 124 shown in FIG. 24) at the corresponding pixel position (method step 154 shown in FIG. 31). Since the scaling information is known from the parameters of the symbol template (method step 100 shown in FIG. 16), the pixel coordinate (method step 154 shown in FIG. 31) of this center can be quantized and memorized. This allows the word matrix to be assigned a logical row and column index. The value and its confidence are then written to this position (method step 156). These two properties are contained in the value in the correlation image K (method step 123 shown in FIG. 24) at the same pixel position. A neighbor, for example the right-hand neighbor, of this center is then sought in the center image (method step 156 shown in FIG. 31). In this context, it is assumed that in a local neighborhood it is approximately true that rows and columns run parallel to the coordinate axes of the image detail and that rows and columns are arranged at right angles to one another.

Either this involves the current image detail being rotated as appropriate (method step 186 shown in FIG. 37), so that this assumption is admissible, or an additional gradient parameter is used for calculating the centers of the symbol neighbors, said gradient parameter likewise being derived from the parameters of the symbol template (method step 182). The pixel coordinate of the neighbor is estimated (method step 127 shown in FIG. 24) by incrementing the current symbol center (method step 154 shown in FIG. 31).

Following the estimation of the center of the symbol neighbor, the center is sought in local surroundings of this estimate (method step 133). This is shown schematically in FIG. 33. First of all, a test is performed to determine whether there is a probable center directly at the estimated coordinates. If not, the one-pixel surroundings of the estimate are searched (FIG. 33, depiction a), which constitutes the possible quantization error. If an extracted center is found in the center image in this way, this is noted separately for the purpose of later recognition of the boundary of the symbol matrix. If a center is still not found, the center is sought in further local surroundings of the presumed cell (FIG. 33, depiction b). This region is typically 50 percent of the symbol template. If a center is found therein, it is marked. If a plurality of centers are found, the center with the maximum confidence value is marked.

If a center has still not been found, it is forced at the originally estimated position or optionally the method according to aspects of the invention which is described below can be used to establish whether there is sufficient evidence that the missing center of a symbol is correctly presumed at that point. This can be asserted when the local surroundings of the presumed center contain a homogenous grayscale value distribution. If this is not the case, an attempt can be made to find a homogenous region of this kind by further displacing the estimated position. If this is also unachievable, the position estimated first of all is ultimately forced.

It is thus possible to generate a rectangle with the estimated coordinate as center (method step 130 shown in FIG. 24) and having the dimensions which are known from the symbol template (method step 129).

This rectangle is usually chosen to be somewhat smaller than the dimensions of the symbol template, for example 25 percent or at least two pixels fewer in extent, in order to take account of noise as a result of symbol centers situated a little too close to one another. It is now possible to test (method step 131) whether all four corners of this rectangle in the dilatation image D (method step 125) have the same confidence or brightness value. If this is the case, it can be assumed that the estimated symbol center is approximately in the center of the neighboring symbol and can be considered to be sufficiently correct. Should there not be the same confidence value at each of the four corners, the rectangle formed can be displaced further right, upward or downward, in order to achieve this condition where possible (method step 132). In this case, the extent of the displacements is limited by the dimensions of the symbol template, which means that it is not possible to skip the adjacent symbol cell. Displacing such a rectangle allows the first estimate to be corrected when perspective distortion means that the above assumption that symbol rows in the symbol matrix run parallel to the coordinate axis is not satisfied.

This method according to aspects of the invention is more robust than the simple pixel search for the extracted center in local surroundings of the estimate. This prevents a noisy center from being set as a neighbor, which is possibly in the vicinity of a bounding line between two symbol cells. Marking such a neighbor increases the risk of running into an upper or lower row of the symbol matrix during further exploration, which means that this results in incorrect associations between the logical rows of the word matrix. If the demanded condition cannot be achieved in this way either, the previous estimate cannot be improved.

Method steps 129 to 132 are optional and can be applied in the case of very noisy center images for the purpose of more robust exploration.

The coordinates of the new center are updated (method step 142) shown in FIG. 24, method step 157 shown in FIG. 31), the position pointer of the word matrix is incremented and the word and the confidence value are written to the word matrix (method step 143 shown in FIG. 24, method step 158 shown in FIG. 31).

Thus, the row is (in the example first of all) ranged to the right, so long as the pixel coordinates are not outside of the image (method step 159). As soon as the pixel coordinates are situated outside of the image, the center pointer is reset to the starting point for this row (method step 160). Next, this row is now ranged to the left on the basis of the same principle (method steps 161 to 164). At the end, the first row has been explored completely, and the values for each symbol or data cell in this logical row in the word matrix are available.

It is now necessary to skip to an upper or lower row, which is then likewise read in as already described. In order to minimize the risk of losing synchronization in this case, that symbol center of the current row with the highest confidence (method step 165) enters the new logical row by incrementing its position pointer. It is to be expected that only small disturbances will occur in the surroundings of such a symbol and that no destroyed regions without center information or with very noisy center information will be encountered. In this way, all cohesive rows of the symbol matrix are explored, and all rows situated beneath (method step 168) the symbol with maximum confidence are processed first of all, for example, followed by those which are arranged above (method step 167) this symbol, in each case until the current pixel position is obtained from the image.

For the purpose of robustly synchronizing the rows and for the purpose of neighbor estimation, second independent estimation of the center can take place by inferring the position of the neighboring symbol not only from the preceding symbol in the same logical row but also, in addition, from an already completely explored symbol position situated logically above (method steps 143, 142 shown in FIG. 24) or below the current row.

Ideally, both estimations produce the same result. If not, one of the results needs to be selected (method step 141).

If one of the two attempts has failed, the generated rectangle (method step 129 or 136) needs to be positioned (method steps 132 and 139) such that the demand for method steps 131 and 138 is met, according to which all corners need to be situated within a symbol. In that case, that center pixel is selected which has been found under the condition (method steps 131 and 138) or meets this condition. A further criterion which may apply for the estimation of a valid center is that one of the two center pixels found is closer to the expected gradient line for the row or column. In this regard, during the exploration, for each marked center pixel (method step 142), for example, the gradient at this point relative to its already traversed neighboring symbols can be memorized. In method step 141, an average can then be formed from a number of two or three previous gradient values. This can be done in the row and column directions. In method 142, that center pixel which is closest to the two gradient lines is then marked. In method step 141, the results of the previous exploration of the current logical symbol row can also be verified subsequently in accordance with aspects of the invention. This is because if a center pixel which meets the demand for method step 131 is found in the column direction (method steps 129 to 133), for example, but a center pixel which is at such a distance from the currently marked symbol center that it represents two increments is found in the row direction (method steps 134 to 140), it is possible the two centers have been marked within the same logical symbol cell on account of center noise. The last marking of the current row can therefore be revered again and corrected. The entry already made (method steps 158 and 163 shown in FIG. 31) in the word matrix is then likewise corrected as appropriate.

When the image detail has now been explored completely (method step 169 shown in FIG. 1), the word matrix can be output which contains the information about the spatial distribution of the words and the respective confidence thereof.

A word matrix produced in this manner possibly contains values at logical positions at which there are actually no symbols present in the symbol matrix. This stems from the fact that center pixels are forced to some extent, in accordance with aspects of the invention, in order to maintain the synchronization. These may need to be filtered out subsequently. To this end, the word matrix can be ranged row by row and column by column, and for each row and column the number of words present which have been read from symbol cells whose center has been forced during exploration is counted. This means that the center was not present in the center image. If the established number is above a threshold value, for example 60 percent of the total number of logical symbols in a row or column, this row or column can be removed from the word matrix completely or can be marked as not read in order to avoid misinformation during the reconstruction. A reconstruction which has a high probability of being mostly incorrect should be avoided, since redundancy incorporated in accordance with aspects of the invention means that it is frequently possible to obtain the information even when a reconstructed row or column is missing.

FIG. 38 describes an alternative method for exploring probable symbol centers which can be used particularly where there is a high level of center noise. For each center pixel in the center image, this method explores its four-neighborhood, i.e. the data cells to the right and left and also at the top and bottom or in the north, south, west and east, for the data cell with the center pixel. These four-neighborhoods are then merged to form a region or to form a plurality of cohesive regions which then indicate the symbol matrix and the corresponding word matrix thereof.

When the center image (method step 126 shown in FIG. 24) has been produced, the centers extracted therein are captured as symbol centers (method step 202 shown in FIG. 38) and are sorted according to increasing confidence (method step 203). The confidence values corresponding to a center are obtained from the absolute value image K2 (method step 124 shown in FIG. 24). In a quick sort method, this can be done by iterating the list elements from the head of the list onward, for example.

For the purpose of exploration, a memory similar to a matrix is created using the same dimensions from the center image. As elements, the memory contains a data structure which represents a symbol such that said symbol can be used to store the four neighbors and also the four symbols, the neighbor of which is the center itself, as symbol pointers. Further properties of the data structure are the pixel coordinates of the center pixel of the symbol, the associated word and the confidence value from the correlation image (method step 123 shown in FIG. 24), a value which indicates whether the center has been forced or extracted, the deviation in the center from the first estimate, gradient information in the east-west and north-south directions of the matrix, which is derived from the neighborhoods, a value which indicates whether this symbol is valid, i.e. that all neighborhood pointers are in use and that all relations such as “go to the symbol to the east, go west from there, arrive at the exit symbol” are true, and a value which indicates that this symbol has already been visited and has been included in the word matrix.

The instances of the data structures are preinitialized in accordance with the center image and are updated in the subsequent steps. Since the symbol cells within the symbol matrix are arranged in grid form, a symbol on the inside has direct neighbors in the east, south, west and north. The coordinates of the four neighbors are respectively estimated (method step 205 shown in FIG. 38). During the estimation, the center coordinates of the current symbol or of the current data cell are incremented as appropriate, it being assumed that the grid-like structure of the arrangement of the symbols in such a local neighborhood exists even in the case of perspective distortion. If the center image has been registered or subjected to perspective distortion removal, the incrementation is effected in axis-parallel fashion. Alternatively, the rotation parameter from method steps 185 and 182 shown in FIG. 37 can be used. The increment is likewise derived from the dimensions of the symbol template.

If a center has been found at the estimated position (method step 206 shown in FIG. 38), the associated neighboring symbol pointer for the current symbol is set to this very center (method step 207). The neighbor itself receives the current symbol in referenced form (method step 209), but only if the reference is not already in use (method step 208). These assignments are then made for all neighborhood directions (method step 210) and all probable centers (method step 211).

The test to determine whether the neighbor is already marked (method step 208) may give rise to ambiguities within a neighborhood relationship, because the reference in method step 209 will not necessarily point to the current symbol, even though the current symbol conversely always references this neighbor (method step 207).

In this connection, the preceding sorting was effected according to decreasing confidence (method step 203), because it is presumed that centers with high confidence are situated very close to actual symbol centers. It is also assumed that coordinates of the neighboring cells can be estimated more reliably from such centers having a high level of confidence than from centers having a low level of confidence.

Since ambiguities have probably been caused by symbol centers with a low level of confidence, these can subsequently be filtered out (method step 212). Since it can be assumed that data cells severely affected by center noise within a symbol matrix have only low confidence values, these incorrect centers can be reliably identified and do not cause any errors in the synchronization of the symbol cells. The center noise within the relevant regions which contain the symbol code is therefore removed. Further center noise outside of the code region cannot be filtered completely, however.

The search for a center in the local surroundings of the estimate in method step 206 is divided into three steps. First of all, precisely the estimated position is checked for a center. If there is no center at that point, the one-pixel neighborhood of the estimate is searched, so that quantization errors in the estimate are covered. If there is no center there either, the estimate is used as a center to search within a rectangle corresponding to the symbol template (method step 185 or 182) for the center with maximum confidence, which is then selected.

During the marking of the symbols without neighborhood ambiguities in method step 212, the gradient parameters can be updated for valid symbols. Thereafter, only those symbols which have a high probability of being able to be associated with actual symbol centers then appear in the list. The sorting is retained and, starting with the first valid symbol, the first cohesive region is ranged and the portion of the logical word matrix which corresponds thereto is produced (method step 213). The resulting subregion is primarily the result of the neighborhood assignments in method step 207, which means that usually only the neighborhood pointers now need to be tracked (method step 219 or 220 followed by method step 225).

At the beginning, the word matrix is initialized and the pointer is set to the current logical element (method step 214). The position of the first element in the word matrix can be set by quantizing the pixel coordinates of the initial center (method step 213) taking account of the dimensions of the symbol template (method step 185 or 182 shown in FIG. 37). The word and the confidence value are copied from the current symbol instance to the current position of the word matrix (method step 215 shown in FIG. 38). The symbol instance is then marked as visited (method step 216). The symbol pointers from the easterly neighbors are then tracked first of all (method step 217), this being an arbitrary selection. In method step 220, the easterly neighbor of the current symbol instance is addressed and is then itself set as the current symbol (method step 225). The position pointer of the logical word matrix is incremented by one increment in accordance with the direction of movement (method step 226). The word and the confidence value are copied from the current symbol instance to the current position of the word matrix (method step 227). The current symbol is then marked as visited (method step 228). If the current symbol has further easterly neighbors or if the end of the center image has not been reached, the iteration is continued in an easterly direction (method step 229). If the end of the image has been reached, the direction is reversed and the search performed from the symbol at which the iteration in this logical row was begun in the converse westerly direction (method step 229). If the end of the image has been reached in this case too, a logical row has been included in the word matrix completely. The next southerly row is now ranged (method step 230). To this end, any symbol in the current row is marked which has a valid southerly neighbor, and this pointer is followed (method step 231). If no symbol with a valid southerly neighbor has been found, a center in a southerly direction is stipulated from that symbol in the current row which has the highest confidence using an increment prescribed by the symbol template. If there is an (invalid) center at precisely that location or in direct local surroundings caused by quantization errors, said center is raised to a valid center, otherwise a center is forced at this position.

In correspondence with this position, the instance situated there in the memory matrix of the symbol instances is initialized or updated. Following the stipulation of the subsequent symbol (method step 231), the position pointer of the word matrix is accordingly incremented (method step 232), the word and the confidence value are copied into the word matrix (method step 215) and the current symbol is marked as visited (method step 216).

This row is now also iterated. Furthermore southerly rows are iterated until there are no further rows in the image (method step 230). Next, each more northerly row which has not already been iterated is ranged according to the same pattern as the southerly rows (method step 233). In this way, the first cohesive portion of the logical word matrix has been explored. In method step 236, a check is performed to determine whether there are further valid symbols which have not yet been visited or explored. These could mark the start of a further cohesive portion of the word matrix if the symbol code is present in a manner split into a plurality of mutually independent surface areas. Thus, further subregions are also entered into the word matrix on the basis of the same scheme, the assurance being provided that no logical positions in the word matrix are addressed more than once.

When all subregions of the symbol code have been explored (method step 236), the resulting word matrix is output with confidence values (method step 239). During the iteration of cohesive surface areas, gaps may remain, which is why not every symbol has a valid neighbor, which means that exploration of the subregions by merely tracking the pointers to neighboring symbols is not sufficient. Such gaps may arise in the case of areal damage to the symbol code or in the case of a very high level of internal center noise. They are caused by neighborhood ambiguities having arisen, or no neighbors exist. Gaps also arise at the boundary of a symbol matrix, since in this case no neighbors outside of the code region exist, which prevents marginal symbols from being marked as valid.

When a gap arises, the position of the neighboring center is estimated (method step 221). The estimation is performed by tracking the neighborhood pointers of the current symbol such that an adjacent row is entered and then a stop is made above or below the symbol to be estimated in the new row. The position of the symbol center at that location is used with the position of the current symbol center for the purpose of estimation. In order to form a narrow search region, the variance in the two known symbol centers relative to their previous estimation can be used. This information is stored in each symbol instance.

If an (invalid) center is found in these local surroundings (method step 222), it is raised to a valid center and the symbol instance thereof is reinitialized. This symbol instance is then activated (method step 225). If no center has been found at that location, such a center is forced at the estimated position (method step 224). The symbol instance at that location is initialized and marked as valid. The symbol neighbors are, as far as possible, derived and set from the known neighborhoods in the surroundings or are updated directly in the iteration step thereon. The new symbol instance is also referenced from the neighboring instances. The estimate of the position can be improved or verified with the gradient information which is available for each valid symbol in the neighborhood, in order to safely bridge relatively large gaps. The symbol instance thus obtained is then updated as an active symbol (method step 225).

This “region merging” method is comparable, in terms of reliability, with previously described “region growing”, but has a shorter runtime when there are a large number of outliers. Since runtime and reliability are two contrasting demands in this case, all variations of the previously described features can be combined and implemented in the methods.

An aspect of the invention is intended to involve adaptive decision-making regarding which of the implemented methods is used in a specific instance and how this method is customized possibly by selecting particular parameters. The aim of this decision is to reduce the runtime on condition that reliability is not diminished. The confidence values of the probable centers are taken into account for the decision. In this regard, a threshold value can be formed, because a generally high level of confidence is a sign of little center noise. In addition, it is possible to calculate the median for all confidence values, for example. With a symbol size of 16 times 16 pixels, less center noise can also be expected than with a symbol size with lateral lengths of 6 times 6 pixels, which is why it is then not necessary to apply a complex method as in FIG. 38 or the optional part in FIG. 24. A further argument for a simple method is a small relative number of probable centers in relation to the size of the image detail. Low expected perspective distortion can also allow simpler methods. Taking account of these considerations, optional parts of the method shown in FIG. 24 can be omitted or the method from FIG. 38 can be applied in order to ensure a high level of reliability.

If, by way of example, a plurality of objects (similar to those shown in FIG. 5) with symbol codes having a different surface area for application are in motion on a conveyor belt, there needs to be a way of identifying each manifestation of the symbol code on the basis of its shape. When the word matrix with confidence values has been produced (method step 170 shown in FIG. 31, method step 193 shown in FIG. 37, method step 239 shown in FIG. 38), the course of the further method for reading the symbol code involves an association being made regarding that instance of the symbol codes applied to various kinds of objects to which the currently available word matrix corresponds. The word matrix may also have data cells, which are not intended to be associated with a symbol, containing a value which stems from a local maximum in the correlation image or from a forced center which has been set during exploration for the purpose of bridging gaps. It may also not be possible to see the surface area for application of the symbol code directly on account of a data cell being occupied or unoccupied. In addition, the extracted word matrix may have an inherent undefined displacement in the logical symbol cells relative to their template—the symbol matrix produced following the encoding.

However, it is necessary to be able to explicitly associate the original template of the read word matrix with said word matrix, because the decoding to be performed is possibly tied to a particular symbol matrix, which means that the supplementary information about the available shape of the word matrix is a prerequisite for successful decoding. Since the graphical symbols in each symbol code maintain their appearance unchanged and there are no incorporated special sequences of symbols for identifying a version of the symbol code, a surface area histogram is produced for each of the symbol codes which are different than the outer or inner shape (method step 61 shown in FIG. 7) or for the surface area for application thereof, as shown in a detail view and by way of example in FIG. 15. In this regard, the geometric focus of the symbol matrix, represented by the cross in FIG. 15, is first of all determined (method step 62 shown in FIG. 7). The position of the focus is in this case indicated in logical row and column indexes for the symbol matrix, with columns and rows describing the arrangement of the graphical symbols.

On the basis of the obtained focus as a center, the entire symbol code is divided into square surface area elements of equal size, which are likewise shown in FIG. 15. The grating of the symbol matrix into surface area elements is chosen such that a plurality of symbols can be assigned to a surface area. If the grating were to be precisely one, each block would contain no more than a single symbol and would therefore be equivalent to the symbol matrix. In this case, however, a coarser grating is desired in order to robustly characterize the shape of the symbol code.

If a surface area element contains at least one symbol or a plurality of symbols, it is assigned the value one. If there is no symbol contained in a surface area element, it is assigned the value zero. The resultant histogram is stored in a database or a static memory (method step 64 shown in FIG. 7). The database contains the surface area histograms for all symbol codes applied to objects (method step 65) and an association between the surface area histograms and the respective symbol codes.

If an unknown version of a symbol code has been explored in a capture station (method step 66), the version thereof is then intended to be determined using its surface area for application before the word matrix is decoded. In method step 67, the matrix of symbol instances (method step 66) is iterated in order to calculate the focus (method step 68). In this case, only symbols whose center has not previously been forced are considered. To improve the calculation further, it is also possible to eliminate symbols whose center has not been estimated exactly or has been estimated only with quantization errors during exploration. Alternatively, the quantization of the captured image region by units of the dimensions of the symbol template can be used to define an upper limit for the number of expected symbol centers in the image provided that the image detail does not have significant levels of perspective distortion.

From the list of symbol centers sorted in rising order on the basis of confidence, precisely this number of first symbol centers is then taken into consideration. In the same way as in method step 63, the surface area histogram is now produced in method step 69. Since the previously ascertained focus is the center of the histogram and the histogram itself is coarse in terms of resolution, it is possible to compensate for the fact that the symbol matrix in the captured image is displaced in relation to its original and that the focus just calculated has not been calculated exactly as a result of center noise which has not been removed entirely but which is severely reduced through the selection of particular symbols.

If individual symbols at boundaries of the symbol code have not been taken into account, this makes an additional contribution to possibly disrupted values in the histogram. In method step 70, that surface area histogram which comes closest or largely corresponds to the currently available one is now sought in the created database. Since all available symbol codes have stored their surface area histogram therein (method step 60 to 65), the one currently being sought must be contained therein. For the histogram comparison, two respective histograms have their focus placed above one another, and the difference between all value-containing data cells in a histogram and the previously ascertained current histogram (method step 69) is than calculated and the absolute values thereof are summed. That histogram from the database which has the lowest error sum is selected as the next (method step 70).

In addition, further information describing the associated symbol code and necessary or useful for decoding the symbol code can be taken from the database (method step 71). This supplementary information is used to parameterize the decoding method (method step 72) and then to make an attempt at decoding (method step 73). If this attempt fails because the histogram association (70) was incorrect (74), a further closest histogram can be read from the database. This may be the case when symbol codes are too similar to one another in terms of their surface area for application.

At the end of its decoding method according to aspects of the invention, the image processing outputs a word matrix which additionally contains confidence values for determining the recognition quality and recognition certainty. The confidence values have been produced by a single filter statistically independently for each word. A further method for decoding this word matrix can use the confidence values in order to allow efficient error correction.

One possible method is proposed in FIG. 40. First of all, the word matrix is produced by means of encoding from a binary data stream (method step 90). By way of example, the word matrix to be produced is divided into locally independent word blocks which each encode a fixed word length for the binary data stream (method step 91). For the purpose of error correction, additional copies of such word blocks can be inserted (method step 93) into the resulting word matrix (method step 94).

For the purpose of decoding, a thus encoded word matrix with confidence values is obtained by the image processing system (method step 95). The algorithm for decoding identifies the independent code blocks within the word matrix. On the basis of the redundancy introduced for decoding, however, not all of these code blocks are needed. Redundant code blocks can now be sorted in descending order on the basis of the established confidence (method step 96), so that when the code blocks are decoded (method step 97) only those with a high recognition certainty are taken into account at first. Since their recognition quality means that these have a relatively great probability of being extracted by the image processing and being present in the word matrix without error, only valid code blocks are thus used for the decoding, which reduces the runtime thereof, since no unnecessary attempts are made at decoding an erroneous code block. The reconstruction of the encoded binary data stream (method step 99) therefore takes place efficiently.

The above-described example, shown in very great detail, of the symbol code according to aspects of the invention and an associated method for reading it reveals substantial advantages both in the symbol code and the decoding method, which are very robust to handle and allow information to be applied to components in a direct part marking method (DPM) even in the domain of ordinary production lines. In the specific application example too, a multiplicity of advantageous features and functions are described which can each separately be used in connection with the symbol code according to aspects of the invention, including in a manner detached from other features within the context of which they are described, since, even when detached from these other features, they make a substantial contribution to the legibility and robustness of the symbol code.

A few more specific application examples are described below.

A symbol code according to aspects of the invention can be applied to a curved reflective surface, with or without translational transformation, with and without a change of scaling. In FIG. 5, cylindrical objects having a metal surface are provided with a symbol code. They are situated on a conveyor belt and are captured by the station in the order A, B, C. The image detail captured by the recognition station is marked by a dashed rectangle at position A. The outwardly similar objects are marked with a symbol code for the purpose of distinction.

The station controls a production separating filter. The symbol code itself contains perspective distortion in the captured image as a result of the cylindrical shape of the surface. On account of the conveyor belt no change in the rotation and scaling parameters occurs, which means that they can be fixed. However, possibly only portions of the symbol matrix are visible, as in positions B and C. Since the graphical symbol code is independent of specific anchor symbols for position recognition and distortion removal, the symbol code can be extracted successfully. On account of the redundant error correction provided by an encoding and decoding algorithm, the binary data record can also be restored.

FIG. 6 shows a further application example. In that case, a plurality of symbol codes have been applied to a matt or reflective and curved surface, with rotational and translational transformation and different scaling. The top part of FIG. 6 shows the object from the point of view of a video camera for image capture. The bottom part of FIG. 6 shows a lateral view of the same object. The station with the video camera oriented in plan view is used for quality control. On account of local restrictions for the checking station and the demand that the assembled component to be checked is evaluated in a single snapshot, the head of a screw joint has been selected for marking with a symbol code. Attachment to the lateral surface areas of the screw joints would result in some of these objects being perspectively concealed by portions which are in front, which means that not every symbol code can be captured simultaneously when the camera is oriented laterally.

Applying the symbol code to the head of the screw joints requires a compact symbol code in order to be able to accommodate the desired information on a small surface area. Some of the screw joints have a curved shape in the head, which causes perspective distortions in the symbol code. All heads are metallic, some shiny, others matt. Furthermore, the heads have different material thicknesses, which means that it is not possible to achieve the best possible contrast when burning with a laser. The screw joints have different heights, which means that the symbol codes in the captured image have different scaling. On account of the screwing, each symbol code in the image has different rotation parameters.

In this case, each of the symbol codes from a head are decoded independently of one another, to which end a respective image detail is defined which contains only one of the symbol codes. The properties of the symbol code described of aspects of the invention and of the extraction method for said symbol code, particularly the normalized correlation used, allow each of the symbol codes to be decoded reliably.

An aspect of the invention describes a graphical symbol code and methods for extracting it in an image processing process. The two graphical symbols for the binary encoding itself have complementary brightness or brightness distribution and each code a single word, i.e.

a binary value. Their inner contour is optimized such that the symbols can not only be read safely and reliably but can also be applied to a usually metallic or plastic-type object surface on a component in a DPM method by means of burning using a laser. In this case, specific properties of the burning process have been analyzed in order to achieve a robust graphical shape for the symbols which allows recognition and distinction even given customary burning errors. In addition, in the case of this shape, application times are minimized, since each symbol can be drawn in vector-oriented fashion in one move without removing a stylus.

With a grayscale-value-normalized correlation, a further aspect of the invention involves the selection of an extraction method which takes account of local alterations in the contrast circumstances, as may be caused by inhomogeneous illumination, local soiling, local reflection of the surface material and/or by limitations in the material thickness.

In order to capture relative local maxima as evidence of a graphical symbol, a further aspect of the invention involves the application of a dilatation filter to a grayscale value image of confidence values, so that no fixed threshold values need to be set and the establishment of a maximum is adaptively matched to the local grayscale value surroundings in the correlation image.

According to aspects of the invention, the proposed symbol code is a symbol code without specific symbols for synchronization or position recognition and for perspective distortion removal, as a result of which it has high density and there is no single point of failure situation when such symbols cannot be extracted.

Drawbacks in the runtime behavior of the more complex correlation in comparison with morphological operators are minimized in accordance with aspects of the invention by virtue of preferably complementary brightness of the graphical symbols requiring only a single filtering operation in order to locate both types of graphical symbols. Preprocessing steps for image conditioning are dispensed with completely, and this reduces the execution time additionally.

With the introduction of independent confidence values for each extracted graphical symbol, this symbol code has a property which can be used by a decoding algorithm according to aspects of the invention for the purpose of efficiently using redundant information for error correction. The confidence values allow an adaptive decision to be made, in accordance with aspects of the invention, regarding whether, given good quality, a fast but not quite so robust algorithm can be applied for exploring the graphical symbols and transforming them into a word matrix or, on the basis of poor quality, a robust but time-consuming algorithm is applied.

The surface area for application of a symbol code and the internal coding thereof can be chosen freely. The decoding takes place after the extracted symbols have been associated with one of the predetermined possible shapes of the symbol code.

1.-15. (canceled)

16. A two-dimensional symbol code for representing binary data, which symbol code is constructed from a plurality of graphical symbols arranged next to one another, wherein the symbol code is formed from precisely two different symbols having the same surface area which differ in their areal brightness distribution and each code a value from a binary data word, wherein the symbols have a complementary brightness distribution.

17. The two-dimensional symbol code as claimed in claim 16, wherein each symbol comprises precisely two regions, wherein the two regions each have a different associated brightness value.

18. The two-dimensional symbol code as claimed in claim 16, wherein the symbol code has a plurality of symbol pairs with a complementary brightness distribution which differ in their color.

19. A method for reading a two-dimensional system code which is constructed from a plurality of graphical symbols arranged next to one another, wherein the symbol code is formed from precisely two different symbols having the same surface area which differ in their areal brightness distribution and each code a value from a binary data word, wherein the two symbols have a complementary brightness distribution, wherein the system code has a filter applied to it which matches the brightness distribution of one of the two complementary symbols, wherein in the event of a match one symbol is recognized and in the event of no match the other symbol is recognized.

20. The method as claimed in claim 19, wherein the filter is a correlation filter which ascertains the result of an interval function which indicates the distance of the present brightness distribution from the brightness distribution of the correlation filter.

21. The method as claimed in claim 20,
wherein the correlation result is ascertained as a confidence value following application of the correlation filter.

22. The method as claimed in claim 21,
wherein when the system code is scanned with the correlation filter a confidence value is ascertained for each scan position and is used to recognize the symbols in the system code.

23. The method as claimed in claim 22,
wherein the confidence values are used to ascertain the most probable centers of the symbols in the symbol code.

24. The method as claimed in claim 23,
wherein from a probable center the other centers of the symbols are explored and the symbols thereof are read.

25. The method as claimed in claim 19,
wherein the color of the symbols is evaluated.

26. The method as claimed in claim 25,
wherein a confidence value is ascertained for a color distribution of the symbols.

27. The method as claimed in claim 19,
wherein the time profile of the confidence values in a region of the system code is evaluated.

28. The method as claimed in claim 19,
wherein the filter and the symbol code are mapped onto one another by a mapping method.

29. The use of a two-dimensional system code as claimed in claim 16, which has been applied to components of a product in an automated production line and has information for denoting the components and/or for controlling the production flow, wherein the system code is captured by readers positioned on the production line and is evaluated by a superordinate control system.

30. An apparatus for reading a two-dimensional system code having an optical recording device and an evaluation device having a processor which is set up to process the optical signals delivered by the recording device and to decode the two-dimensional symbol code,
wherein the processor in the evaluation unit has a method as claimed in claim 19 implemented in it.
